(19) United States
(12) Patent Application Publication
(10) Pub. No.: US 2009/0156454 A1
(43) Pub. Date: Jun. 18, 2009

(54) GRANULATES FOR A SENSITIVE WASHING- OR CLEANING AGENT CONTAINING MATERIAL

(75) Inventors: Peter Schmiedel, Duesseldorf (DE); Petra Padurschel, Erkrath (DE); Heribert Kaiser, Duesseldorf (DE); Anette Nordskog, Duesseldorf (DE); Wolfgang von Rybinski, Duesseldorf (DE); Regina Stehr, Neuss (DE); Karl-Heinz Maurer, Erkrath (DE); Cornelius Bessler, Duesseldorf (DE); Soeren Hoelsken, Duesseldorf (DE); Rolf Tenhaef, Duesseldorf (DE)

Correspondence Address: Ratner Prestia, P.O. Box 980, Valley Forge, PA, 19482, US

(73) Assignee: HENKEL AG & CO. KGaA, Duesseldorf (DE)

(21) Appl. No.: 12/254,350

(22) Filed: Oct. 20, 2008

Related U.S. Application Data
(63) Continuation of application No. PCT/EP2007/053678, filed on Apr. 16, 2007.

(30) Foreign Application Priority Data
Apr. 20, 2006 (DE) 10 2006 018 790.6

(51) Int. Cl. C11D 17/00; C11D 3/37; C11D 7/42; C11D 9/00; C11D 17/08; C11D 3/395

(52) U.S. Cl. 510/302; 510/276; 510/320; 510/360; 510/361; 510/349; 510/353; 510/337; 510/336

(57) ABSTRACT

Granulates for washing- or cleaning agents, containing (a) a sensitive washing- or cleaning agent component, (b) an adsorbent carrier material, (c) a binder that is different from (b), and (d) optional additional substances that are different from (b) and (c). The granulates display a disintegration index of at least 50 percent after 24 hours. These granulates are particularly suited for use in liquid- or gel-forming aqueous washing- or cleaning agents. Also, a procedure for the manufacture of such granulates, in regards to washing- or cleaning agents.

### CROSS REFERENCE TO RELATED APPLICATIONS

This application is a continuation under 35 U.S.C. §§ 120 and 365(c) of International Application PCT/EP2007/053678, filed on Apr. 16, 2007. This application also claims priority under 35 U.S.C. § 119 of DE 10 2006 018 790.6 filed on Apr. 20, 2006. The disclosures of PCT/EP2007/053678 and DE 10 2006 018 790.6 are incorporated by reference in their entirety.

### BACKGROUND OF THE INVENTION

The present application relates to granulates of sensitive ingredients of laundry detergent or cleaning compositions, processes for manufacturing such granulates, corresponding laundry detergent and cleaning compositions as well as the use of suitable components for manufacturing such granulates.

There exists an extensive prior art for the incorporation of sensitive ingredients of laundry detergent or cleaning compositions, especially of enzymes in solid form. It includes particles or even better, because they consist of a plurality of ingredients: granulate particles (grains, pellets) that summed together produce the presentation form of the granulate. For manufacturing laundry detergent and cleaning compositions it is common practice to incorporate the most varied ingredients in the form of granulates in suitable, mostly solid agents.

A fundamental alternative to this is illustrated by the incorporation of enzymes in liquid form, which are generally mixed into predominantly liquid or gelled laundry detergent and cleaning compositions. However, in this form they are not physically protected against negative influences of other ingredients of the laundry detergent and cleaning compositions in question. In regard to some ingredients, this disadvantage can be overcome by adding chemicals; thus by adding inhibitors, proteases, for example, are prevented from hydrolyzing other enzyme molecules. The negative influences from repeated freezing and thawing can be compensated, for example by the addition of polyols. Other ingredients, especially bleaching agents however, can be inhibited only with difficulty from negatively affecting sensitive ingredients during storage.

In order to protect enzymes and also other sensitive ingredients against the influence of other ingredients in predominantly liquid or gelled laundry detergent and cleaning compositions, various solutions have been proposed in the prior art. One consists of suitably designing the total formulation. Thus, for example, WO 2004/110610 A1 discloses the stabilization of peroxycarboxylic acids in a surfactant-containing, aqueous dispersion by minimizing the halide ion contents, by lowering the pH to between acidic and neutral pH values, by minimizing the content of free or active surfactants, minimizing the non-ionic surfactant content, adding complexants, adding catalases, adding a solvent that is a poor solvent for peroxycarboxylic acids etc. Here it was also attempted if at all possible to not even add potential reaction partners, to reduce the dissolution of the peroxycarboxylic acid by controlling the ion strength and to slow down the water-induced hydrolysis reaction.

Another approach consisted in encapsulating the aggressive ingredient such that it cannot react with any other ingredient during the storage of the liquid composition. Thus for example, a storage-stable, multilayer polyelectrolyte capsule system is disclosed in WO 2004/110610 A1 for coating particles with organic peroxycarboxylic acids. As an alternative coating possibility, these types of capsules are described in WO 2004/110612 A1, which possess a capsule hull based on at least one inorganic salt such as for example a sulfate. A further alternative to this are the presentation forms of the bleaching agent in WO 2004/110611 A1: gel capsules, which comprise and encase the peroxycarboxylic acids. However, these approaches lead to unsatisfactory results in regard to the storage stability of the enzymes. Especially at storage temperatures above 35° C., the concentration of dissolved bleaching agent increases to a barely acceptable level for practically all these solutions soon after making-up the formulations.

A fundamentally different approach consists of adding the sensitive ingredients in the form of solid granulates to the liquid laundry detergent and cleaning compositions. This idea builds on the extensive experience collected from the manufacture of enzyme granulates for use in solid compositions. In fact, enzyme granulates are often described in the prior art for use in laundry detergent and cleaning compositions, wherein however, only in the rarest cases liquid compositions are mentioned; mainly one speaks generally of laundry detergent and cleaning compositions, without overtly differentiating between liquid and solid compositions. This is attributed to the fact that liquid and gelled compositions have only been intensively developed since a few years and previous documents of the prior art practically always dealt with solid compositions. Granulates developed for solid compositions are generally unsuitable for incorporation in liquid, especially aqueous compositions, because they are physically unstable in them, i.e. they rapidly disintegrate from the action of the solvent.

Adding enzymes in solid form to liquid compositions was disclosed in WO 99/00471 A1 and WO 99/00478 A1. In both cases the enzymes were made up into prills, as is also normally the case when adding them in solid compositions, i.e. without an exterior protection over this solid form. Moreover in both cases this concerned anhydrous compositions. The first of these applications teaches that these solid particles, in regard to their density, match that of the medium, i.e. below 1.7 g/ml, so as to ensure an adequate stability of the particles during storage. The second of these applications teaches in this context that the cleaning power of the comprised enzymes is increased by adding the compound ethylenediamine-N—N′-disuccinic acid (EDDS) or its salts.

The subsequent developments chiefly concentrated on additionally covering the enzyme granules or particles with other ingredients with a protective coating. For example, WO 00/29534 A1 discloses the manufacture of granulates, in which various layers are deposited on an inert core or carrier. There can also be an enzyme layer among these, which has an obligatory external covering of one or a plurality of protective coatings. The materials titanium dioxide, methyl cellulose (Methocel A15), polyethylene glycol (PEG 600), polyvinyl alcohol (Elvanol 51-05) and a specific non-ionic surfactant (Neodol 23-6.5) are disclosed as the protective coatings for the enzyme. According to the description, these granules exhibit high stability and low dust numbers. The applicability in liquid, and anhydrous or essentially anhydrous compositions was indeed suggested but not documented. A possible applicability for predominantly aqueous compositions was certainly not considered.

PEG-containing coatings for granulates that comprise enzymes for this field of application are documented for example in WO 96/38527 A1 and WO 97/391 16 A1. Here, the PEG-containing layer can also comprise titanium dioxide. A fundamental interchangeability of PEG and PVA for this purpose is disclosed for example in WO 00/63336 A1.

A liquid depositable coating system for sensitive ingredients that can also be used in aqueous compositions is also disclosed in EP 1 586 241 A1. It consists of 60-95 wt. % of wax, 3-25 wt. % of fatty acid, 0-20 wt. % of additives and a sufficient amount of alkali metal ions to neutralize at least 70% of the total quantity of free carboxylic groups of the fatty acid. That means that it is a wax/soap/fatty acid mixture.

Furthermore, the encapsulation of the sensitive ingredients in hydrophobic or waxy materials or even the establishment of multiphase systems is described in the prior art. Thus, according to WO 01/23513 A1, enzymes can be encapsulated in a wax and added in this form to liquid laundry detergent and cleaning compositions, the compositions disclosed in this application being practically anhydrous.

The application EP 0 356 239 A2 discloses a system whereby enzymes are evenly dispersed in a protective, specific polymer material (matrix) or are coated with same (polymeric shell). They are supposedly physically stable when stored in low water content, liquid laundry detergent or cleaning composition, whereby the integrity of the enzymes is ensured, and they first decompose when diluted with water at the beginning of the wash cycle. WO 92/20771 A1 fundamentally discloses the same solution for liquid laundry detergent formulations with a water content of up to 60 wt. %.

The applications WO 2005/028603 A1 and WO 2005/028604 A1 disclose liquid laundry detergent and cleaning composition with a water content of up to 70 wt. %, in which the comprised enzymes are stabilized by the fact that they are encapsulated in a gel. This is formed with the aid of specific silanes. In these cases as well, the encapsulated ingredients are protected in storage and are only released when diluted in the aqueous wash liquor.

The application US 2005/0245418 A1 describes the encapsulation of enzymes in a water-soluble gel for use in aqueous laundry detergent and cleaning compositions.

EP 0 653 485 A1 teaches the dissolution or the suspension of sensitive ingredients such as enzymes in oil and to incorporate these oil droplets in polymer capsules. These capsules are designed such that they can be added to a liquid medium, for example a laundry detergent containing up to 35 wt. % water, and only burst open and release their contents when further diluted in the wash liquor.

Yet another compartmentalization method is taught by WO 03/106607 A1. Thus, enzymes or enzyme crystals can be kept stable in the aqueous phase with the aid of surfactants in a hydrophobic silicone environment, wherein the silicone phase is again stabilized by surfactants in a hydrophilic external phase.

The established methods for making up chemically sensitive ingredients, especially enzymes, for use in liquid or gelled, particularly aqueous laundry detergent or cleaning compositions are not satisfactory. They are either liquid and thereby chemically very delicate preparations, a part of the otherwise required active substances, especially bleaching agent, must be avoided, the granulates are physically or chemically unstable or they are only obtained in stable form by means of very complex, i.e. time-intensive and expensive coating systems. This set of problems is illustrated by the fact that practically no liquid or gelled laundry detergent or cleaning composition that contains water, bleaching agent and enzymes are commercially available at this time.

### DESCRIPTION OF THE INVENTION

Accordingly, there still exists the need for methods for the essentially stable conditioning, especially of enzymes, for use in liquid or gelled laundry detergent or cleaning compositions, especially in aqueous compositions. In particular, there exists a need for comparatively less elaborate, i.e. cheaper conditioning methods, for example without adding expensive stabilizing compounds such as for example for liquid preparations or without elaborate encapsulation techniques using polymer chemistry as in the case of solid preparations, and without having to avoid the use of a part of the otherwise required active substances, especially bleaching agents, in the laundry detergent or cleaning compositions, in which the sensitive ingredients are intended to be added.

In the light of this background, the object of the invention is to develop a conditioning form, in which sensitive ingredients, especially enzymes during storage in laundry detergent and cleaning compositions, particularly in liquid and quite particularly in aqueous laundry detergent and cleaning compositions, are adequately protected against deactivation, for example by aggressive, especially bleaching ingredients. Advantageously, it should also be comparatively cheap to realize.

This object is achieved by a granulate of a sensitive ingredient of laundry detergent or cleaning compositions, comprising the components:

(a) the sensitive ingredient of laundry detergent or cleaning composition,

(b) a particulate carrier material (adsorbent),

(c) an ingredient that is different from (b) as the binder and

(d) optional additional ingredients that are different from (b) und (c),

which has a disintegration index of at least 50% after 24 hours.

These granulates are characterized in that they are essentially physically stable, particularly in liquid or gelled laundry detergent or cleaning composition formulations, and moreover demonstrate an effective protection against other compounds. Thus, as is documented in the examples of the present application, the activities of the enzyme components that were granulated in this way are retained at a high level for a surprisingly long time in otherwise liquid compositions. In particular, there results a protection against bleaching agent comprised in such compositions. Moreover, when used in laundry detergent and cleaning compositions they show a good disintegration and dissolution behavior at the moment of application and enable a rapid release of the comprised substances, practically without leaving behind any residues on the washing. What is more, they can be comparatively easily manufactured.

In the context of the present invention, a granulate is understood to mean a solid conditioned form, in which a plurality of ingredients—in this case therefore the components (a), (b), (c) and optionally (d)—are not prepared in powder form but rather in the form of discrete particles or granulated grains (shot, pellets). Their sum is designated as the granulate. Generally speaking, granulates do not have a harmoniously geometric shape; their surface can be if anything smooth, uneven or even jagged. In many cases, the material is more or less porous.

They are preferably granulates, whose granulated grains have an essentially uniform size and/or an approximately spherical shape.

Production methods per se are known to the person skilled in the art. For example in chapter 6 (“Production of Powdered detergents”) of the article “Laundry detergents” in Ullmann's Encyclopedia of Industrial Chemistry (Wiley, VCH, 2005), various established methods of the prior art for conditioning diverse chemical compounds are described, in particular for application in laundry detergent and cleaning compositions. Among these are also mentioned extrusion methods, by which comparatively high densities and dust-free products can be produced. According to this compilation, extrusion can also be used to prepare sensitive ingredients such as enzymes. According to the invention this is particularly advantageous, because the exposure of the enzyme preparation to heat can be kept low. In principle, according to the invention all known extrusion processes can be used. Accordingly, those inventive granulates that as a result of this manufacturing process can also be designated as extrudates are preferred.

An alternative process to extrusion is available, for example, from the handbook “Wirbelschicht-Sprühgranulation” (Fluidized bed spray granulation) by H. Uhlemann and L. Morl, Springer-Verlag, Berlin, Heidelberg, New York, 2000, ch. 1 (Grundlagen der Wirbelschicht-Sprühgranulation), (Fundamentals of fluidized bed spray granulation) pp. 69 to 126, and ch. 8 (Verfahrensvarianten) (Process variants), pp. 219 to 244.

In the context of the present invention, a sensitive ingredient of laundry detergent or cleaning compositions (a) is understood to mean any compound that in the context of a laundry detergent or cleaning composition formulation affords a positive and desirable contribution to the laundry or cleaning performance of the composition in question and which can be impaired in regard to its performance by the action of at least one other substance of the same formulation or also by other interfering substances (for example from the air or the packaging material). Examples of such sensitive ingredients of laundry detergent or cleaning compositions are:
enzymes (for example proteases, amylases or cellulases) which can be at least partially inactivated. for example. by bleaching ingredients;
fragrances or perfumes (for example alcohols, aldehydes, ketones, esters or unsaturated compounds) which can be converted, for example, by means of oxidizing ingredients into the corresponding different or non-fragrant derivatives, for example the carboxylic acids;
optical brighteners (for example biphenyl derivatives with condensed double bonds) which can lose the fluorescing behavior by forming adducts with the double bonds;
bleach activators (for example peracids) which can react prematurely, i.e. already during storage, with the bleaching agent, such that the composition loses overall bleaching power.

A characterizing aspect of the invention is that the sensitive ingredient of the laundry detergent or cleaning composition is processed with the components (b) and (c) to an essentially uniform granulate.

In the context of the present invention, a particulate carrier material (b) prior to incorporation into inventive granulates is understood to mean a room temperature-solid, powdery or particulate material that is chemically so inert that under the conditions of manufacture, processing and storage of the granulate, it reacts with none of the other ingredients of the granulate or the composition to any degree that impairs the overall activity of the granulate. Due to its structure it can bind, to some degree physically, liquids or gelled or pasty substances on its surface, such that in connection with the present invention it can also be identified as an adsorbent.

They include inorganic substances such as for example clays, silicates or sulfates, especially talcum, silicic acid, metal oxides, especially aluminum oxides, silicates, especially layered silicates, sodium aluminum silicates, bentonites and/or alumosilicates (zeolites) and/or titanium dioxide. They also include organic compounds such as for example polyvinyl alcohol (PVA), particularly at least partially hydrolyzed PVA. It is particularly advantageous when these compounds fulfill an additional use, for example a builder function when added to the laundry detergent or cleaning composition. PEG has not proved to be particularly advantageous, so that it is not included by the present invention, at least not as a characterizing feature of a preferred embodiment of the adsorbent and particularly preferably is not even comprised as part of the absorbent.

In the context of the present invention, a binder (b) is understood to mean a room temperature-solid, pasty (waxy) or liquid material that is likewise chemically so inert that under the conditions of manufacture, processing and storage of the granulate, it reacts with none of the other ingredients of the granulate or the composition to any degree that impairs the overall activity of the granulate. It is a different substance than (b). Under the conditions of granulate manufacture it is or at least becomes so viscous that it virtually glues the other ingredients together. In this respect, the physiochemical interaction with the adsorbent is particularly important, as this enables the resulting mass to become an overall homogeneous phase that can be subsequently converted into individual granulate particles. This mass that is formed predominantly from the adsorbent components and the binder components, entraps the other ingredients and especially the ingredient to be conditioned. The interaction between both the components (b) and (c) is particularly responsible for the physical stability of the granulate particles.

Suitable binders are inorganic or organic substances that have the described properties, for example uncrosslinked, polymeric compounds selected from the group: polyacrylates, polymethacrylates, methacrylic acid-ethyl acrylate copolymers, polyvinyl pyrrolidones, polysaccharides or substituted polysaccharides, in particular cellulose ethers, polyvinyl alcohols (PVA), preferably partially hydrolyzed polyvinyl alcohols and/or ethoxylated polyvinyl alcohols as well as their copolymers and mixtures. Polyethylene glycol has not proved to be particularly advantageous in this regard, so that it is not a preferred embodiment of the binder and particularly preferably is not even comprised as part of the binder.

Some compounds such as for example PVA, due to their adsorption properties and their simultaneous binding action, are suitable both as component (b) as well as component (c). According to the invention, they can then be employed as (c), when they have not already been presented as (b).

In the context of the present invention, optional additional ingredients (d) are understood to mean fundamentally all compounds that are chemically so inert that under the conditions of manufacture, processing and storage of the granulate, react with none of the other ingredients of the granulate or the composition to any degree that impairs the overall activity of the granulate.

Plasticizers represent a noteworthy fraction of these optional ingredients. They are compounds or mixtures that can be added in order to improve the manufacturing process of the granulates. In particular, they exert a physical chemical effect on the viscosity and/or plasticity (tensile strength of the extruded strand etc.) of the compound to be granulated. They preferably make up a weight fraction of 0 to 50 wt. % (based on the granulate). They are preferably selected from the following group: water-dispersible organic polymers, polyethylene glycol (PEG), especially short chain PEGs, fatty acids or salts of fatty acids, triacetin and/or triethyl citrate or polyhydric alcohols such as for example 1,2-propanediol or glycerine.

Solubility improvers (also known as swelling agents, disintegration aids or disintegrators) likewise represent a noteworthy fraction of these optional ingredients. They are compounds or mixtures that can be added in order to improve the solubility of the granulate at the moment when, according to the invention, they are intended to actually disintegrate, namely in the instant of application of the composition in question. Indeed, laundry detergent and cleaning compositions are generally employed in diluted form, i.e. added to an aqueous wash liquor. In this moment of strong dilution with water, water diffuses into the granules that thereupon burst open and release their ingredient with the result that it can start acting. This disintegration process can be improved by adding solubility enhancers.

This can also result in a timing control, for example in the sense that the granulated ingredient only goes into solution somewhat later than one or a plurality of other ingredients of the composition. Accordingly, one embodiment of the present invention is illustrated when, for example, granulated enzymes start to act with a delay compared with any bleaching agent contained in the composition, such that a part of the bleaching agent will have already reacted in the wash liquor and the enzyme will no longer be so strongly impaired. Of course, in an analogous manner the action of the bleaching agent or the bleach activator can also be delayed.

The solubility enhancers preferably make up a weight fraction of 0 to 50 wt. % (based on the granulate). They are preferably selected from the following group: water-soluble inorganic salts, monosaccharides, preferably glucose, oligosaccharides, and swelling agents, in particular compounds suitable as disintegrators, especially cellulose, compacted cellulose, cellulose derivatives and/or crosslinked organic polymers, preferably crosslinked polyvinyl pyrrolidones or crosslinked polyacrylates.

A further fraction of these optional ingredients is made up, for example of water, enzyme stabilizers, colorants, pigments, pH buffers, antioxidants, density-regulating compounds and/or additional ingredients. They preferably make up a weight fraction of 0 to 40 wt. % (based on the granulate).

Among the optionally present ingredients can also be for example the constituents of the fermentation media, which result from the enzyme manufacture and which have not been completely separated. Their presence is then particularly advantageous when they exert a stabilizing influence on the enzyme. If the ingredient is a complicated chemical compound, for example a perfume, it can also be accompanied by other intermediates or stereoisomers, which result from the synthesis and which have not been completely separated.

With further ingredients, it can concern compounds that exert an additional effect in the context of the intended later use of the granulate in a laundry detergent or cleaning composition, and which can consequently also be designated as a “benefit agent”.

In the manufacture of the granulate, water is generally carried over only as an impurity, for example with the aqueous enzyme preparation. A certain water content can lend a favorable consistency to the mash being processed, especially for extrusion. Furthermore, a certain equilibrium water content occurs on storing the granulate particles in an aqueous medium, but this generally does not impair the integrity of the particles as a whole. During the required dissolution process, i.e. at the instant of strong dilution of the composition in an aqueous liquor, the water content is increased so strongly that the particles completely disintegrate.

Consequently, one of the included ingredients (d) is therefore also water. The water content of the grains is controlled especially by the nature of their manufacture. Thus, in the fluidized bed spray granulation of an aqueous mixture of ingredients, for example, a considerable part of the water is removed by evaporation. Particularly with the manufacture of granulates by extrusion of a plastic compound, where there is normally no subsequent drying step, the water content of the granulate is controlled by those of the added compounds, for example by an incorporated liquid enzyme preparation.

Enzyme stabilizers are comprised as preferred additional ingredients, particularly in enzyme-containing granulates. They are particularly useful as a protection, particularly in storage, against deteriorations such as, for example inactivation, denaturation or decomposition, for example through physical influences, oxidation or proteolytic cleavage.

An inhibition of the proteolysis is particularly preferred during microbial preparation of proteins and/or enzymes, particularly when the compositions also contain proteases. Preferred granulates (or compositions; see below) according to the invention comprise stabilizers for this purpose.

One group of stabilizers are the reversible protease inhibitors. For this, benzamidine hydrochloride, borax, boric acids, boronic acids or their salts or esters are frequently used, above all derivatives with aromatic groups, for example ortho, meta or para substituted phenyl boronic acids, particularly 4-formylphenyl boronic acid or the salts or esters of the cited compounds. Peptide aldehydes, i.e. oligopeptides with a reduced C-terminus, particularly those from 2 to 50 monomers are also used for this purpose. Ovomucoid and leupeptin, among others, belong to the peptidic reversible protease inhibitors. Specific, reversible peptide inhibitors for the protease subtilisin and fusion proteins from proteases and specific peptide inhibitors are also suitable.

Further enzyme stabilizers are amino alcohols like mono-, di-, triethanol- and -propanolamine and their mixtures, aliphatic carboxylic acids up to C₁₂, such as, for example succinic acid, other dicarboxylic acids or salts of the cited acids. End-capped fatty acid amide alkoxylates are also suitable for this purpose. Certain organic acids used as builders can additionally stabilize an enzyme.

Lower aliphatic alcohols, but above all polyols such as, for example glycerine, ethylene glycol, propylene glycol, sorbitol or diglycerine phosphate are further frequently used enzyme stabilizers against physical influences. Similarly, calcium and/or magnesium salts are used, such as, for example calcium acetate or calcium formate.

Polyamide oligomers or polymeric compounds like lignin, water-soluble vinyl copolymers or cellulose ethers, acrylic polymers and/or polyamides stabilize enzyme preparations inter alia against physical influences or pH variations. Polymers containing polyamine-N-oxide act simultaneously as enzyme stabilizers and color transfer inhibitors. Other polymeric stabilizers are linear C₈-C₁₈ polyoxyalkylenes. Alkyl polyglycosides can also stabilize the enzymatic components of the inventive agents and are additionally capable of advantageously increasing their performance. Crosslinked nitrogen-containing compounds chiefly perform a dual function as soil release agents and as enzyme stabilizers. A hydrophobic, non-ionic polymer stabilizes in particular an optionally present cellulase.

Reducing agents and antioxidants increase the stability of enzymes against oxidative decomposition; sulfur-containing reducing agents are commonly used here, for example sodium sulfite and reducing sugars.

The use of combinations of stabilizers is particularly preferred, for example of polyols, boric acid and/or borax, the combination of boric acid or borate with reducing salts and succinic acid or other dicarboxylic acids or the combination of boric acid or borate with polyols or polyamino compounds and with reducing salts. The effect of peptide-aldehyde stabilizers is conveniently increased by the combination with boric acid and/or boric acid derivatives and polyols and still more by the additional effect of divalent cations, such as for example calcium ions.

Solids can be added so as to improve the esthetic impression of the granulate particle or so as to absorb onto the washing during the application of the laundry detergent or cleaning composition. They are advantageously incorporated such that they are uniformly dispersed in the whole particle. They are known per se in the prior art.

Pigments can likewise serve to improve the esthetic impression of the granulate particle. They can also be uniformly distributed in the particle. Here, however, the major aspect is particularly to cover the particle surface with pigments in order to mask the inherent coloration of the granulate. This is also known per se in the prior art. A white pigment that is frequently used for this is titanium dioxide.

pH buffers can be incorporated in order to protect the ingredients in question against pH influences during storage, for example from the surrounding medium. However, they can also be incorporated in order to leave the particle at the same time as the ingredient only when added and enter the wash liquor, thereby influencing the pH of the wash medium. In this way, a pH shift can be provoked, for example simultaneously with the release of an enzyme with a specific pH activity profile in order to improve its activity.

Antioxidants can be incorporated particularly to provide a protection against atmospheric oxygen or other oxidizing agents during storage.

The use of density-regulating substances in granulates is known per se. Thus, for example, the density can be reduced by adding perlite, starch or feather particles or be increased by adding clay or silicate crystals. This is advantageous in order to match the bulk density of the particles with the bulk density of the solid laundry detergent and cleaning composition, in order to avoid demixing processes during transport or storage. In regard to an intended use of the granulate in liquid or gelled compositions, in the same way the density of the composition in question can be matched, such that the granulates are macroscopically homogeneously dispersed in the composition in question and in the ideal case neither sink nor float on the surface.

In the context of the present invention, disintegration is understood to mean the macroscopically observed decomposition of the granulate grains. A slight possible swelling of the granulate grains in a strongly water-containing environment, which does not significantly impair the activity of the granulated ingredients, is not meant here and can be consistently observed with granulates according to the invention. Similarly, it is consistent with the invention if a slight abrasion occurs, which can possibly be observed in a liquid or gelled preparation comprising the inventive particles, as a suspended matter and/or leads to a slight turbidity. What is decisive is that after the period of contemplated storage, one can still speak of a discrete granulate that can be differentiated with the naked eye as an individual solid, particulate phase particularly from the sodium sulfate/sodium citrate solution according to the invention, which serves as the reference.

In the context of the present invention, storage is understood to mean keeping the preparation in question at a constant 23° C. for at least 24 hours and increasingly preferably for at least 30 h, 36 h, 42 h, 48 h, 3 days, 4 days, 5 days, 6 days and most preferably for at least 7 days. This takes place in a sealed, air tight, non-evacuated container, wherein the volume of the air phase does not exceed that of the measuring liquid. The reference system is an aqueous buffer system consisting of 16% sodium sulfate and 3% sodium citrate, pH 5.0±0.1.

For the experimental determination of whether any disintegration has occurred according to the invention after this period of time, the liquid containing the granulates is subjected to a sieving test. For this it is quantitatively given without the use of a pressure or vacuum on a sieve that has a smaller mesh size than the granulate, such that the granulate is retained by the sieve. The mesh size of the sieve can be 280 μm for example. The sieve is rinsed with a recently prepared sodium sulfate/sodium citrate solution and then with distilled water. This test procedure is described in Example 11, wherein an additional low speed shaking was made during the incubation; this is not absolutely necessary according to the invention. One then speaks of an inventive non-disintegration if, after drying the residue, more than 50 wt. % of the originally weighed out mass of particles (before being stirred into the solution) remained on the sieve. Increasingly preferably, more than 60, 70, 80, 90 and quite particularly preferably more than 95% of the originally weighed out mass of particles remain on the sieve.

The disintegration index for the particles in question is defined as the ratio of the remaining mass of particles (residue) on the sieve and the originally weighed out mass of particles and is reported as weight % residue, wherein the residue is determined after the particles were stored for a defined period in an aqueous buffer system consisting of 16% sodium sulfate and 3% sodium citrate in water, pH 5.0±0.1. The period of time is at least 24 hours and increasingly preferably at least 30 h, 36 h, 42 h, 48 h, 3 days, 4 days, 5 days, 6 days and most preferably at least 7 days. The numerical value of the disintegration index is therefore the higher, the fewer particles that disintegrated during the period of the storage and were not retained on the sieve. A non-disintegration according to the invention then occurs when the disintegration index is at least 50%. The disintegration index is increasingly preferably 60, 70, 80, 90 and quite particularly preferably more than 95%.

The inventive solution can be assigned to all ingredients given above in connection with the present invention. Indeed, they are fundamentally all similarly endangered, particularly from oxidation, and in principle are protected in the same way according to the invention.

In a particular embodiment of the enzyme granulate, the measure of disintegration can be related not to the predominant retention of the mass of the particle, but rather to the retention of the enzyme activity. The enzyme activity can be determined using known methods depending on the processed enzyme. Thus, it was experimentally determined that for the granulates described in the examples as inventive, not only the major part of the original weighed out particle masses (before stirring into the solution) remained on the sieve, but also a major part of the enzymatic activity. This is more than 50% and increasingly preferably more than 60, 70, 80, 90 and quite particularly preferably more than 95%. In contrast, granulates from the prior art, which were structurally different, showed markedly worse values, including those with an inert core (of MgSO₄), onto which an enzyme-containing coating had been deposited. In the above described sieve test, these particles showed an apparently largely retained physical stability (if also not more than 50% according to the above described sieve test), but the enzymatic layer was rapidly washed away, such that these granulates for the inventively stated purposes are unusable.

Such inventive granulates form preferred embodiments of the present invention, wherein the components (b) and (c) are present in a weight ratio of (b) to (c) of 1:50 to 50:1, preferably from 1:20 to 20:1, particularly preferably from 1:5 to 5:1.

Indeed, the described synergy of both these components arises especially in these relations. The formulations described in the examples of the present application show particularly suitable ratios of weight fractions within these given limits.

Real mixing ratios in individual cases are optimized experimentally such that, firstly a not too great excess of adsorbent remains which would leave the compound too brittle, and secondly a not too great excess of binder remains which could cause the resulting compound to be sticky and therefore difficult to process. It should be taken into account here that the additional components, depending on each of their properties, also exert an influence on the condition of the material and the granulate particles.

Preferred embodiments of the present invention are formed by those inventive granulates comprising the components:

(a) the sensitive ingredient of laundry detergents or cleaning composition,

(b) 10-80 wt. % of a particulate carrier material (adsorbent),

(c) 3-50 wt. % of an ingredient that is different from (b) as the binder and

(d) as the optional further ingredients that are different from (b) and (c):
0-50 wt. % (based on the granulate) plasticizer,
0-50 wt. % (based on the granulate) solubility enhancer (swelling agent, disintegration aid, disintegrator), and/or
0-40 wt. % (based on the granulate) water, enzyme stabilizers, colorants, pigments, pH buffer substances, antioxidants, density regulating compounds and/or additional ingredients.

Individual preferred ingredients for these components have already been listed above and will also be given below once again as the correspondingly preferred embodiments. It is particularly advantageous to employ a combination of two or three of the cited substances from each of these groups, especially from that of the adsorbents and from that of the binders.

A substance that can be considered for several of these components may only be counted once, such that in each case of an inventive granulate there is always at least a mixture of the components (a) with (b) and a component (c) that differs from them. The core of the invention consists in matching adsorbent and binder to one another in a coordinated manner so as to obtain granulates with favorable properties. When adding additional optional components or differently prepared components (a) (for example enzyme preparations with different total protein or water contents), each of the weight ratios has to be optimized experimentally. The above described sieve test, after suitable storage in the cited sodium sulfate/sodium citrate solution, serves as a guideline for this.

On employing the cited proportions of materials, advantageous stabilization effects were observed with enzyme-containing granulates. Thus from Example 1 of the present application, granulates contain ca. 5 wt. % of component (a), 36 wt. % of component (b), 18 wt. % of component (c) and under (d) a fraction of 31 wt. % plasticizer and ca. 10 wt. % water. A part of the particulate carrier material, namely the TiO₂, makes up 13 wt. % of the total mass of the granulate and additionally serves in the cited formulation as a pigment. Thus from Example 2 of the present application, granulates contain ca. 5 wt. % of component (a) (enzyme), 31 wt. % of component (b), 22 wt. % of component (c) and under (d) a fraction of 24 wt. % plasticizer, ca. 8 wt. % solubility enhancer and ca. 10 wt. % water. A part of the particulate carrier material, namely the TiO₂, makes up 8 wt. % of the total mass of the granulate and additionally serves in the cited formulation as a pigment. Example 3 discloses granulates with only 5 wt. % of component (a) (enzyme), 78 wt. % of various components (b), 7 wt. % of component (c) and a water content (d) of ca. 10 wt.-%.

As can be noted from Example 3, more than 50 wt. %, preferably more than 60 wt. % and quite particularly preferably more than 70 wt. % due to the fraction of adsorbent (b) are then particularly advantageous, when the optional further ingredients (d) are predominantly dispensed with, i.e. together they make up less than 40 wt. %, preferably less than 30 wt. % and particularly preferably less than 20 wt. % of the granulate.

Preferred embodiments of the present invention are formed by such described inventive granulates, wherein the sensitive laundry detergent or cleaning composition ingredient (a) concerns a perfume, an optical brightener, a bleach activator or an enzyme, preferably an enzyme, particularly an enzyme stabilized against oxidation.

These substance groups themselves have already been listed above, but will be described in more detail again.

Fragrances are added to the laundry detergents or cleaning compositions in order to improve the esthetic impression of the product and to provide the consumer not only with the required washing and cleaning performance but also with a visually and sensorially “typical and unmistakable” product. In particular it can be desired to confer a certain fragrance to the washing, for example to the fabric, which will also remain after the end of the wash cycle.

The volatility of an odoriferous substance is crucial for its perceptibility, whereby in addition to the nature of the functional groups and the structure of the chemical compound, the molecular weight also plays an important role. Thus, the majority of odoriferous substances has molecular weights up to about 200 daltons, and molecular weights of 300 daltons and above are quite an exception. Due to the different volatilities of odoriferous substances, the smell of a perfume or fragrance composed of a plurality of odoriferous substances changes during the course of evaporation, the impressions of odor being subdivided into the “top note”, “middle note” or “body” and “end note” or “dry out”. As the perception of smell also depends to a large extent on the intensity of the odor, the top note of a perfume or fragrance consists not solely of highly volatile compounds, whereas the endnote consists to a large extent of less volatile, i.e. tenacious odoriferous substances. In the composition of perfumes, higher volatile odoriferous substances can be bound, for example onto particular fixatives, whereby their rapid evaporation is impeded. In the following subdivision of odoriferous substances into “more volatile” or “tenacious” odoriferous substances, nothing is mentioned about the odor impression and further, whether the relevant odoriferous substance is perceived as the top note or body note.

Individual odoriferous compounds, for example the synthetic products of the ester, ether, aldehyde, ketone, alcohol and hydrocarbon type, can be used as fragrances. Odoriferous compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various odoriferous substances, which together produce an attractive fragrant note, are preferably used. Perfumes such as these may also contain natural odoriferous mixtures obtainable from vegetal sources, for example pine, citrus, jasmine, patchouli, rose or ylang-ylang oil. Also suitable are muscatel oil, oil of sage, chamomile oil, clove oil, melissa oil, mint oil, cinnamon leaf oil, lime blossom oil, juniper berry oil, vetivert oil, olibanum oil, galbanum oil and laudanum oil and orange blossom oil, neroli oil, orange peel oil and sandalwood oil. The content of fragrances in laundry detergents or cleaning compositions is usually up to 2 wt. % of the total formulation. This is to be taken into account when designing inventive granulates for use in laundry detergents and cleaning compositions.

Alternative embodiments of the present invention concern granulates of optical brighteners. This established class of ingredients, in particular for textile detergents, affords what is considered as a positive visual impression of the laundered washing.

Preferred embodiments of this aspect of the invention concern derivatives of diaminostilbene sulfonic acid or its alkali metal salts. Suitable optical brighteners are, for example, salts of 4,4′-bis-(2-anilino-4-morpholino-1,3,5-triazinyl-6-amino)stilbene-2,2′-disulfonic acid or compounds of similar structure which contain a diethanolamino group, a methylamino group, an anilino group or a 2-methoxyethylamino group instead of the morpholino group. Optical brighteners of the substituted diphenylstyryl type may also be present, for example the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the abovementioned brighteners may also be used. Mixtures of optical brighteners from a distyrylbiphenyl derivative and a stilbene triazine derivative are particularly suitable. These brighteners can be employed in any mixing ratio of one another. These types of brightener are available, for example, from Ciba under the trade name Tinopal®.

The laundry detergents can also comprise bleach activators in order to achieve a good bleaching action for wash temperatures of 60° C. and below and particularly during the pre-treatment wash. In the context of the present invention, these ingredients, due to their reactivity, are also conditioned in the form of inventive granulates.

Bleach activators, which can be used, are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable.

Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular 1,3,4,6-tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, isatoic anhydride and/or succinic anhydride, carboxylic acid amides, such as N-methyldiacetamide, glycolide, acylated polyhydric alcohols, in particular triacetin, ethylene glycol diacetate and 2,5-diacetoxy-2,5-dihydrofuran and the enol esters as well as acetylated sorbitol and mannitol or their mixtures (SORMAN), acylated sugar derivatives, in particular pentaacetyl glucose (PAG), pentaacetyl fructose, tetraacetyl xylose and octaacetyl lactose as well as acetylated, optionally N-alkylated glucamine and gluconolactone, triazole or triazole derivatives and/or particulate caprolactams and/or caprolactam derivatives, preferably N-acylated lactams, for example N-benzoyl caprolactam and N-acetyl caprolactam. Hydrophilically substituted acyl acetals and acyl lactams are also preferably used, Combinations of conventional bleach activators may also be used. Nitrile derivatives such as cyanopyridines, nitrilequats, for example N-alkylammonium acetonitrile, and/or cyanamide derivatives can also be used. Preferred bleach activators are sodium 4-(octanoyloxy)benzene sulfonate, n-nonanoyl- or isononanoyloxybenzene sulfonate (n- or iso-NOBS), undecenoyloxybenzene sulfonate (UDOBS), sodium dodecanoyloxybenzene sulfonate (DOBS), decanoyloxybenzoic acid (DOBA, OBC 10) and/or dodecanoyloxybenzene sulfonate (OBS 12), and N-methylmorpholinum acetonitrile (MMA).

In the context of the present application, further preferred added bleach activators are compounds from the group of the cationic nitriles, particularly cationic nitriles of the Formula

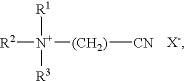

in which R¹ stands for —H, —CH₃, a C₂₋₂₄ alkyl or alkenyl group, a substituted C₂₋₂₄ alkyl or alkenyl group having at least one substituent from the group of —Cl, —Br, —OH, —NH₂, —CN, an alkylaryl or alkenylaryl group having a C₁₋₂₄ alkyl group or for a substituted alkylaryl or alkenylaryl group having a C₁₋₂₄ alkyl group and at least one further substituent on the aromatic ring, R² and R³ independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion.

A cationic nitrile of the following Formula is particularly preferred

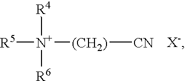

in which R⁴, R⁵ und R⁶ independently of one another are selected from —CH₃, —CH₂—CH₃, —CH₂—CH₂—CH₃, —CH(CH₃)—CH₃, wherein R⁴ can also be —H and X is an anion, wherein preferably R⁵=R⁶=—CH₃ and in particular R⁴=R⁵=R⁶=—CH₃ and compounds of the formulae (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻, or (HO—CH₂—CH₂)₃N⁽⁺⁾CH₂—CNX⁻ are particularly preferred, wherein once again from the group of these substances the cationic nitrile of the formula (CH₃)₃N⁽⁺⁾CH₃X⁻, in which X⁻ stands for an anion selected from the group chloride, bromide, iodide, hydrogen sulfate, methosulfate, p-toluene sulfonate (tosylate) or xylene sulfonate is particularly preferred.

Bleach activators are comprised in the usual quantity range of 0.01 to 20 wt. %, preferably in amounts of 0.1 to 15 wt. %, particularly 1 wt. % to 10 wt. %, based on the total laundry detergent or cleaning composition compound. This is to be taken into account when designing inventive granulates for use in laundry detergents and cleaning compositions.

Preferred embodiments of the present invention concern granulates of enzymes. This established class of ingredients, depending on their respective specificity, affords a corresponding improvement in the cleaning power of the compositions in question. These particularly include proteases, additional amylases, lipases, hemicellulases, cellulases or oxidoreductases such as peroxidases and/or perhydrolases, as well as preferably their mixtures. In principle, these enzymes are of natural origin; improved variants based on the natural molecules are available for use in laundry detergents or cleaning compositions and accordingly they are preferred.

Compositions furnished with granulates according to the invention preferably comprise enzymes in total quantities of 1×10⁻⁸ to 5 weight percent, based on active protein. This is to be taken into account when designing inventive granulates for use in laundry detergents and cleaning compositions.

The protein concentration can be determined using known methods, for example the BCA Process (bicinchoninic acid; 2,2′-biquinolyl-4,4′-dicarboxylic acid) or the biuret process (A. G. Gornall, C. S. Bardawill and M. M. David, J. Biol. Chem., 177 (1948), pp. 751-766).

In regard to the use of the inventive granulates in the context of laundry detergents and cleaning compositions, component (a) includes one or a plurality of hydrolytic enzymes and/or oxidoreductases, particularly preferably α-amylases, proteases, lipases, cutinases, hemicellulases, cellulases, β-glucanases, oxidases, katalases, peroxidases and/or laccases, among these the particularly preferred oxidation stabilized α-amylases, proteases, lipases, cutinases, hemicellulases, cellulases, β-glucanases, oxidases, peroxidases and/or laccases.

Preferred embodiments of this subject matter are formed by those enzyme granulates, wherein the enzyme is one or a mixture of the following enzymes: protease, amylase, cellulase, hemicellulase, oxidase and perhydrolase, preferably one of these enzymes that is oxidation stabilized.

Preferred proteases are those of the subtilisin type. Examples of these are subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisins, thermitase, proteinase K and the proteases TW3 und TW7. Subtilisin Carlsberg in further developed form is available under the trade name Alcalase® from Novozymes A/S, Bagsværd, Denmark. Subtilisins 147 and 309 are commercialized under the trade names Esperase® and Savinase® by the Novozymes company. Variants derived from the protease from Bacillus lentus DSM 5483 (WO 91/02792 A1) called BLAP® are described especially in WO 92/21760 A1, WO 95/23221 A1, WO 02/088340 A2 and WO 03/038082 A2. Further useable proteases from various Bacillus sp. and B. gibsonii emerge from the patent applications WO 03/054185 A1, WO 03/056017 A2, WO 03/055974 A2 and WO 03/054184 A1.

Further useable proteases are, for example, those enzymes available under the trade names Durazym®, Relase®, Everlase®, Nafizym, Natalase®, Kannase® and Ovozymes® from the Novozymes Company, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of conditionable amylases according to the invention are the α-amylases from Bacillus licheniformis, from B. amyloliquefaciens or from B. stearothermophilus, as well as their improved further developments for use in laundry detergents or cleaning compositions. The enzyme from B. licheniformis is available from the Novozymes Company under the name Termamyl® and from the Genencor Company under the name Purastar®ST. Further development products of this α-amylase are available from the Novozymes Company under the trade names Duramyl® and Termamyl® ultra, from the Genencor Company under the name Purastar®OxAm and from Daiwa Seiko Inc., Tokyo, Japan as Keistase®. The α-amylase from B. amyloliquefaciens is commercialized by the Novozymes Company under the name BAN®, and derived variants from the α-amylase from B. stearothermophilus under the names BSG® and Novamyl® also from the Novozymes Company.

Moreover, for these purposes, attention should be drawn to the α-amylase from Bacillus sp. A 7-7 (DSM 12368) disclosed in the application WO 02/10356 A2 and the cyclodextrin-glucanotransferase (CGTase) from B. agaradherens (DSM 9948) described in the application WO 02/44350 A2. Furthermore, the amylolytic enzymes are useable, which belong to the sequence space of α-amylases, described in the application WO 03/002711 A2 and those described in the application WO 03/054177 A2. Similarly, fusion products of the cited molecules are applicable, for example those from the application DE 10138753 A1 or their point mutations.

Moreover, further developments of α-amylase from Aspergillus niger and A. oryzae available from the Company Novozymes under the trade name Fungamyl® are suitable. Additional commercial products that can be used are for example the Amylase-LT® and Stainzyme®, the latter also from the Novozymes company. Variants of these enzymes obtained by point mutations can also be incorporated in inventive granulates.

The granulates according to the invention can comprise lipases or cutinases, particularly due to their triglyceride cleaving activities, but also in order to produce in situ peracids from suitable preliminary steps. These include for example the available or further developed lipases originating from Humicola lanuginosa (Thermomyces lanuginosus), particularly those with the amino acid substitution D96L. They are commercialized, for example by the Novozymes Company under the trade names Lipolase®, Lipolase® Ultra, LipoPrime®, Lipozyme® and Lipex®. Moreover, suitable cutinases, for example are those that were originally isolated from Fusarium solani pisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina and Fusarium solanii are for example available from the Genencor Company. Further important commercial products that may be mentioned are the commercial preparations M1 Lipase® and Lipomax® originally from Gist-Brocades Company, and the commercial enzymes from the Meito Sangyo KK Company, Japan under the names Lipase MY-30®, Lipase OF® and Lipase PL® as well as the product Lumafast® from the Genencor Company.

Granulates according to the invention, particularly when they are destined for treating textiles, can comprise cellulases, according to their purpose, as pure enzymes, as enzyme preparations, or in the form of mixtures, in which the individual components advantageously complement their various performances. Among these aspects of performance are particular contributions to primary washing performance, to secondary washing performance of the product, (anti-redeposition activity or inhibition of graying) and softening or brightening (effect on the textile), through to practicing a “stone washed” effect.

A usable, fungal endoglucanase(EG)-rich cellulase preparation, or its further developments are offered by the Novozymes Company under the trade name Celluzyme®. The products Endolase® and Carezyme® based on the 50 kD-EG, respectively 43 kD-EG from H. insolens DSM 1800 are also obtainable from Novozymes Company. The latter is based on the application WO 96/29397 A1. Performance enhanced cellulase variants emerge from the application WO 98/12307 A1, for example. It is equally possible to use the cellulases disclosed in the application WO 97/14804 A1; for example the 20 kD EG disclosed therein from Melanocarpus, and which is available under the trade names Ecostone® and Biotouch® from AB Enzymes, Finland. Further commercial products from the AB Enzymes Company are Econase® and Ecopulp®. Further suitable cellulases from Bacillus sp. CBS 670.93 and CBS 669.93 are disclosed in WO 96/34092 A2, the CBS 670.93 from Bacillus sp. being obtainable under the trade name Puradax® from the Genencor Company. Other commercial products from the Genencor Company are “Genencor detergent cellulase L” and IndiAge® Neutra.

The granulates according to the invention for use in laundry detergent or cleaning compositions can comprise additional enzymes especially for removing specific problem stains and which are summarized under the term hemicellulases. These include, for example mannanases, xanthanlyases, pectinlyases (=pectinases), pectinesterases, pectatlyases, xyloglucanases (=xylanases), pullulanases und β-glucanases. Suitable mannanases, for example are available under the names Gamanase® and PektinexAR® from Novozymes Company, under the names Rohapec® B1 from AB Enzymes, under the names Pyrolase® from Diversa Corp., San Diego, Calif., USA, and under the names Purabrite® from Genencor Int., Inc., Palo Alto, Calif., USA. A suitable β-Glucanase from a B. alcalophilus emerges from the application WO 99/06573 A1, for example. β-Glucanase extracted from B. subtilis is available under the name Cereflo® from the Novozymes Company.

To increase the bleaching action, the granulates according to the invention can also comprise oxidoreductases, for example oxidases, oxygenases, catalases (that react at lower H₂O₂ concentrations than peroxidase), peroxidases, like halo-, chloro-, bromo-, lignin-, glucose- or manganese-peroxidases, dioxygenases or laccases (phenoloxidases, polyphenoloxidases). Suitable commercial products are Denilite® 1 and 2 from the Novozymes Company. For an advantageously employable exemplary system for an enzymatic perhydrolysis, reference may be made to the application WO 98/45398 A1. Particularly for such a system, WO 2004/058955 A2, for example, discloses suitable cholinoxidases. Modified proteases having a pronounced perhydrolase activity, which can likewise be advantageously used for this, especially to produce a mild bleach in textile detergents, are disclosed in the application WO 2004/058961 A1. A combined enzymatic bleach system, containing an oxidase and a perhydrolase, is described in the application WO 2005/124012. Further perhydrolases that can be employed according to the invention are also disclosed in WO 2005/056782 A2. Advantageously, additional, preferably organic, particularly preferably aromatic compounds are added that interact with the enzymes to enhance the activity of the oxidoreductases in question or to facilitate the electron flow (mediators) between the oxidizing enzymes and the stains over strongly different redox potentials.

In the context of the present invention, those granulates are particularly preferred, which comprise an enzymatic bleach system according to the international patent application WO 2005/124012 or a component thereof. A preferred embodiment of the invention is therefore illustrated by granulates that comprise a part of an enzymatic bleach system, containing at least one oxidase and at least one perhydrolase, wherein the oxidase is selected among
a) choline oxidases, whose amino acid sequence matches that listed in SEQ ID No. 2 in the international patent application WO 2005/124012 to at least 76.5%, increasingly preferably to at least 78%, 80%, 82%, 84%, 86%, 88%, 90%, 92%, 94%, 95%, 96%, 97%, 98%, 99% and particularly preferably to 100%,
b) choline oxidases, whose amino acid sequence matches that listed in SEQ ID No. 4 in the international patent application WO 2005/124012 to at least 89%, increasingly preferably to at least 90%, 92%, 94%, 95%, 96%, 97%, 98%, 99% and particularly preferably to 100%,
c) choline oxidases, whose amino acid sequence matches that listed in SEQ ID No. 6 in the international patent application WO 2005/124012 to at least 83.8%, increasingly preferably to at least 84%, 86%, 88%, 90%, 92%, 94%, 95%, 96%, 97%, 98%, 99% and particularly preferably to 100%,
d) choline oxidases, whose amino acid sequence matches that listed in SEQ ID No. 28 in the international patent application WO 2005/124012 to at least 76.4%, increasingly preferably to at least 78%, 80%, 82%, 84%, 86%, 88%, 90%, 92%, 94%, 95%, 96%, 97%, 98%, 99% and particularly preferably to 100%, and
e) choline oxidases according to a), b), c) or d), which are obtainable by one or multiple conservative amino acid exchanges from a choline oxidase according to a) to d) or by derivatization, fragmentation, deletion mutation or insertion mutation of a choline oxidase according to a) to d);
   and/or the perhydrolase is selected among
f) perhydrolases, whose amino acid sequence corresponds to that listed in SEQ ID NO. 26 in the international patent application WO 2005/124012, but carries one or a plurality of exchanged amino acids at the sequence positions selected from 11, 15, 21, 38, 50, 54, 58, 77, 83, 89, 93, 96, 107, 117, 120, 134, 135, 136, 140, 147, 150, 154, 155, 160, 161, 171, 179, 180, 181, 194, 205, 208, 213, 216, 217, 238, 239, 251, 253, 257, 261,
g) perhydrolases, whose amino acid sequence corresponds to that listed in SEQ ID NO. 26 in the international patent application WO 2005/124012, but carries one or a plurality of exchanged amino acids at the sequence positions selected from 11, 58, 77, 89, 96, 117, 120, 134, 135, 136, 140, 147, 150, 161, 208, 216, 217, 238,
h) perhydrolases, whose amino acid sequence corresponds to that listed in SEQ ID NO. 26 in the international patent application WO 2005/124012, but carries one or a plurality of exchanged amino acids at the sequence positions selected from 58, 89, 96, 117, 216, 217,
i) perhydrolases, whose amino acid sequence corresponds to that listed in SEQ ID NO.26 in the international patent application WO 2005/124012, but exhibits one or a plurality of amino acid exchanges T58A or T58Q, L89S, N96D, G117D L216W and N217D,
j) perhydrolases, whose amino acid sequence matches the amino acid sequences listed in the SEQ ID NO. 8, 10, 12, 14, 16, 18, 20, 22 or 24 in the international patent application WO 2005/124012, increasingly preferably to at least 70%, 72.5%, 75%, 77.5%, 80%, 82.5%, 85%, 87.5%, 90%, 92.5%, 95%, 97.5% and quite particularly preferably to 100%.

For the disclosure of the abovementioned sequences of the perhydrolases, reference is made to the disclosure in the international patent application WO 2005/124012.

The enzymes used in the granulates according to the invention either stem originally from microorganisms, such as the species Bacillus, Streptomyces, Humicola, or Pseudomonas, and/or are produced according to known biotechnological processes using suitable microorganisms such as by transgenic expression hosts of the genus Bacillus or by filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

In analogy with the above stated embodiments, the enzymes can be inventively conditioned together with impurities, for example from the fermentation or with stabilizers.

Among all these enzymes, those are particularly preferred, which are comparatively stable against oxidation or which have been stabilized for example by point mutagenesis. Among these are particularly to be cited the already mentioned commercial products Everlase and Purafect® OxP as examples of such proteases and Duramyl as an example of such an α-amylase.

This is particularly true for the embodiments of the present invention, in which the granulates are not yet protected by an additional coating (see below). In this form, particularly during storage in a liquid laundry detergent or cleaning composition, the granulates come into contact with the damaging substances (if also in a far lesser degree than if they were not at all or not granulated according to the invention). Above all, the enzyme molecules in the proximity of the granulate surface are endangered in this way, especially in the case where a certain amount of solvent permeates into the granulates (also without totally disintegrating them). Thus it is particularly advantageous if the enzymes in question exhibit a certain degree of basic stability towards an oxidative inactivation.

In the granulate manufacture (see below) it is inventively particularly advantageous if a liquid enzyme preparation, for example coming directly from the fermentative manufacture, is incorporated in aqueous solution into the mash for manufacturing the granulate. These types of “liquid enzyme” preparations are also commercially available, particularly of proteases and amylases that are destined for use in laundry detergent and cleaning compositions. Liquid protease preparations, for example, with an enzyme protein content of 0.1 to 50%, preferably 5 to 40%, particularly preferably 10 to 35% are suitable for the manufacture of the granulates. They can be optionally adjusted by means of methods known to the person skilled in the art (for example concentration by rotational evaporation or dilution by the addition of buffer) to a suitable concentration for further processing.

Preferred embodiments of the present invention are formed by granulates according to the invention, which comprise as the component (b) (adsorbent) one or a plurality of the compounds selected from the group: talcum, silicic acid, aluminum oxide, silicate, especially layered silicate and/or sodium aluminum silicate, bentonite, alumosilicates (zeolite), sulfate, titanium dioxide and/or polyvinyl alcohol (PVA), especially partially hydrolyzed PVA, particularly preferably a combination of two or three of these compounds.

Typical commercial polyvinyl alcohols, which are offered as yellowish white powders or granules having degrees of polymerization in the range of approx. 500 to 2500 (molar masses of approximately 20 000 to 100 000 g/mol), have degrees of hydrolysis of 98-99 or 87-89 molar % and thus still have a residual acetyl group content. Fully saponified polyvinyl alcohols have a glass transition temperature of 85° C. and a melting point of 228° C. The corresponding values for partially hydrolyzed (87-89%) products are significantly lower at ca. 58° C. respectively 186° C. The latter “partially hydrolyzed” PVA are particularly suitable according to the invention.

Granulates with these components (b) were characterized by a remarkable stability and when used in the context of a laundry detergent or cleaning composition formulation, by an excellent solubility in conditions of use. This is documented in the examples of the present application.

Preferred embodiments of the present invention are formed by granulates according to the invention, which comprise as the component (c) (binder) one or a plurality of the compounds selected from the group: polyacrylate, polymethacrylate, polyvinyl pyrrolidone, polysaccharide or substituted polysaccharide, especially cellulose ethers, polyvinyl alcohol (PVA), especially partially hydrolyzed PVA or ethoxylated PVA, a copolymer of the cited compounds, especially methacrylic acid-ethyl acrylate copolymer, particularly preferably a combination of two or three of these compounds.

Indeed, granulates with these components (c) were characterized by a remarkable stability and when used in the context of a laundry detergent or cleaning agent formulation by an excellent solubility in conditions of use. This is documented in the examples of the present application.

Exemplary suitable substances that may be cited are the crosslinked polyvinyl pyrrolidone Collidon CL (commercial product of BASF, Ludwigshafen) and the methacrylic acid-ethyl acrylate copolymer Eudragit L100 (Degussa, Frankfurt/M.) and Collicoat MEA (BASF).

Preferred embodiments of the present invention are formed by granulates according to the invention, which comprise as the component (d) (plasticizer) one or a plurality of the compounds selected from the group: water dispersible organic compounds or water dispersible organic polymers, especially polyethylene glycol (PEG), quite particularly short chain PEG, fatty acids or salts of fatty acids, triacetin, triethyl citrate and/or polyhydric alcohols, preferably fatty acids or salts of fatty acids, particularly preferably sodium stearate and/or sodium oleate.

Indeed, granulates with these parts of the components (d) were characterized by a remarkable stability and when used in the context of a laundry detergent or cleaning composition formulation, by an excellent solubility in conditions of use. This is documented in the examples of the present application.

Preferred embodiments of the present invention are formed by granulates according to the invention, which comprise as the component (d) (solubility enhancer) one or a plurality of the compounds selected from the group: water-soluble inorganic salts, monosaccharides, especially glucose, oligosaccharides, polysaccharides, especially cellulose, compacted cellulose or cellulose derivatives, crosslinked organic polymers, especially crosslinked polyvinyl pyrrolidone or crosslinked polyacrylate.

Indeed, granulates with these parts of the components (d) were characterized by a remarkable stability and when used in the context of a laundry detergent or cleaning composition formulation, by an excellent solubility in conditions of use. This is documented in the examples of the present application.

In order to facilitate the disintegration of the inventive granulates, it is possible to incorporate strongly hygroscopic and/or compounds that swell in contact with water as the so called solubility enhancers or even to incorporate disintegration aids. In this way the disintegration times are reduced. They are known per se in the prior art. According to Römpp (9th Edition, Vol. 6, page 4440) and Voigt “Lehrbuch der pharmazeutischen Technologie” (6th Edition, 1987, pp 182-184), tablet disintegrators or disintegration accelerators are auxiliaries, which provide for the rapid disintegration of tablets in water or gastric juices and the release of the pharmaceuticals in an absorbable form.

These substances, which are also known as disintegrators by virtue of their effect, increase in volume on contact with water such that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

In the context of the present invention, disintegrants based on cellulose are the preferred disintegrants.

Preferred embodiments of the present invention are formed by inventive granulates comprising the components:
(a) enzyme, preferably an oxidation-stable enzyme,
(b) 20-80 wt. % of a particulate carrier material (adsorbent), selected from the group: aluminum oxides, silicates, especially sodium aluminum silicates, alumosilicates (zeolites), sulfates, titanium dioxide and/or polyvinyl alcohol (PVA), preferably partially hydrolyzed PVA, particularly preferably a combination of two or three of these ingredients,
(c) 5-50 wt. % of a polymeric binder, selected from the group: polyacrylates, methacrylic acid-ethyl acrylate copolymers and/or polyvinyl alcohol (PVA), preferably partially hydrolyzed PVA, particularly preferably a combination of two or three of these ingredients, and
(d) as optional further ingredients:
   0-50 wt. % (based on the granulate) plasticizer, selected from the group of the fatty acids or the salts of fatty acids,
   0-50 wt. % (based on the granulate) solubility enhancer, selected from the group of the monosaccharides, preferably glucose and/or
   0-25 wt. % (based on the granulate) water and/or pigments.

Indeed, granulates included therein were investigated in connection with the present invention and were successful in regard to their stability and their solubility under conditions of use of an appropriate laundry detergent or cleaning composition. This emerges from the examples and is discussed in more detail there and already above.

Preferred embodiments of the present invention are formed by inventive granulates comprising the components:
(a) 3 to 30 wt. % of the sensitive ingredient of the laundry detergent or cleaning composition,
(b) 20-80 wt. % of a particulate carrier material (adsorbent), selected from the group: talcum, silicic acid, aluminum oxides, silicates, especially layered silicates, sodium aluminum silicates, bentonites and/or alumosilicates (zeolites), sulfates, titanium dioxide and/or polyvinyl alcohol (PVA), preferably partially hydrolyzed PVA,
(c) 5-25 wt. % of a non-crosslinked, organic, polymeric binder, selected from the group: polyacrylates, methacrylic acid-ethyl acrylate copolymers, polyvinyl pyrrolidones, polysaccharides or substituted polysaccharides, especially cellulose ethers, polyvinyl alcohols (PVA), preferably partially hydrolyzed PVA and/or ethoxylated polyvinyl alcohols, and
(d) as optional further ingredients:
   0-33 wt. % (based on the granulate), plasticizer, selected from the group: water-dispersible organic compounds, water-dispersible organic polymers, polyethylene glycols (PEG), especially short chain PEG, fatty acids or salts of fatty acids, triacetin and/or triethyl citrate or polyhydric alcohols such as for example 1,2-propanediol or glycerine.
   0-10 wt. % (based on the granulate), solubility enhancer, selected from the group: water-soluble inorganic salts, monosaccharides, preferably glucose, oligosaccharides, and swelling agents, in particular compounds suitable as disintegrators, especially cellulose, compacted cellulose, cellulose derivatives
   and/or crosslinked organic polymers, preferably crosslinked polyvinyl pyrrolidones and/or 10-25 wt. % (based on the granulate) water, enzyme stabilizers, colorants, pigments, pH buffer substances, antioxidants, density regulating compounds and/or additional ingredients.

Indeed, granulates included therein were investigated in connection with the present invention and were successful in regard to their stability and their solubility under conditions of use of an appropriate laundry detergent or cleaning composition. This emerges from the examples and is discussed in more detail there and already above.

In this regard, quite particularly preferred granulates according to the invention have the following compositions:
(a) 3 to 7 wt. % enzyme, preferably an oxidation-stable enzyme,
(b) 30-80 wt. % of a particulate carrier material (adsorbent), selected from the group: aluminum oxides, silicates, especially sodium aluminum silicates, alumosilicates (zeolites), sulfates, titanium dioxide and/or polyvinyl alcohol (PVA), preferably partially hydrolyzed PVA, particularly preferably a combination of two or three of these ingredients,
(c) 5-25 wt. % of a polymeric binder, selected from the group: polyacrylates and/or polyvinyl alcohols (PVA), preferably hydrolyzed PVA, particularly preferably a combination of two or three of these ingredients, and
(d) as optional further ingredients:
   0-33 wt. % (based on the granulate) plasticizer, selected from the group of the fatty acids or the salts of fatty acids,
   0-10 wt. % (based on the granulate) solubility enhancer, selected from the group of the monosaccharides, preferably glucose and/or
   10-25 wt. % (based on the granulate) water and/or pigments.

Indeed, granulates included therein were investigated in connection with the present invention and were successful in regard to their stability and their solubility under conditions of use of an appropriate laundry detergent or cleaning composition. This emerges from the examples and is discussed in more detail there and already above.

A further embodiment of the present invention relates to an inventive granulate that is additionally coated with a mono or multilayer coating.

This additional coating particularly provides additional protection to the ingredients, but can also fulfill other purposes, for example delayed release, improvements in the bulk density characteristics, for example lowering dusting, increasing stability and/or improving the visual impression.

These types of granulates of the so called core/shell type and processes and equipment for their manufacture are known per se. The manufacturing processes are also mostly reflected in the design of the coating. Overviews of these processes and equipment can be found for example in the handbooks “Wirbelschicht-Sprühgranulation” by H. Uhlemann and L. Mörl, Springer-Verlag, Berlin, Heidelberg, New York, 2000, ch. 14.3 (Umhullen/Encapsulation), pp. 461 to 473, and “Agglomeration Processes. Phenomena, Technologies, Equipment” by W. Pietsch, Verlag Wiley-VCH, Weinheim, 2002.

The granulates according to the invention can be manufactured for example by means of a turbojet, described in the thesis by Karin Wöstheinrich, “Einsatzmöglichkeiten des Hüttlin-Kugelcoaters HKC 05-TJ unter Einbeziehung von Simulationen”, which can be consulted as an online thesis at the url http://w210.ub.uni-tuebingen.de/dbt/volltexte/2000/134/index.html (consulted 5 Apr. 2004).

In a suitable coating process, the granulate particles, preferably enzyme particles, are introduced in the flow of hot air and the coating material is sprayed on by a top-sprayer. This is carried out under dry conditions, i.e. 40-45° C., such that the product has a temperature of about 35-38° C. and remains dry.

Preferred processes and process products of this type are characterized in that the enzyme granulate particles are coated with an aqueous emulsion based on silicone oil.

No less preferred processes and process products of this type are characterized in that the enzyme granulate particles are coated with a polymer solution comprising an inorganic pigment.

This concerns, for example, processes and process products with the polymer components PEG, PVA, PVP, starch, starch derivatives, cellulose, cellulose derivatives or their mixtures or their copolymers, and kaolin, TiO₂ and/or antioxidants as the inorganic pigment.

It can be advantageous here to incorporate the polymer in the form of an aqueous solution, for example as an aqueous PEG solution. Surfactant, for example non-ionic surfactant with ca. 80 EO, can also be optionally incorporated in the coating.

The following coating processes and the resulting inventively coated granulates are particularly preferred:

(1.) a pigment-containing coating of: (a) 5 to 70 wt. % (based on the coating) of a fine, inorganic, water-insoluble pigment, (b) 45 to 79 wt. % of an inorganic substance with a melting point of 40 to 70° C. and (c) up to 20 wt. % of a bulk density improving agent; such a coating emerges from EP 0 944 704 B1;
(2.) a coating, comprising a multivalent metal salt of an unbranched or branched, unsaturated or saturated mono- or polyhydroxylated fatty acid having at least 12 carbon atoms, is deposited; such a coating emerges from WO 03/020868 A1;
(3.) a mixture of TiO₂, urea and polyethylene glycol with a water content of less than 50 wt. % is deposited; such a coating is described in the not prior published application DE 102004062326.0.
(4.) emulsions based on silicone oil, wherein these are deposited in the form of water-in-oil emulsions (W/O), oil-in-water emulsions (O/W), multiple emulsions (W/O/W) and nano- and micro emulsions;
(5.) abrasion-resistant, coated enzyme granulates according to the not prior published application DE 102004062326.0, which can be manufactured by depositing a urea-containing aqueous preparation onto granulate particles, and the water is at least partially removed by drying. According to this application, the fines of the uncoated granulate are firstly advantageously removed by a two-step air elutriation and the highly abrasion-resistant layer of urea/PEG/TiO₂ having a water content of less than 50% is then deposited.

A preferred embodiment of the present invention concerns an inventively coated granulate, wherein the coating consists of more than 50 wt. % of one or more of the following compounds: water-dispersible substances, water-dispersible and/or water-soluble polymer, fatty acid, salt of a fatty acid, fatty alcohol, paraffin, polyvinyl acetate, polyacrylate, polymethacrylate, methacrylic acid-ethyl acrylate copolymer, polyvinyl pyrrolidone, cellulose ether, polyvinyl alcohol and ethoxylated polyvinyl alcohol.

Indeed, as is shown by the examples of the present application, granulates according to the invention having an additional polymer coating exhibit increased stability values.

A preferred embodiment concerns a polymer-coated granulate according to the invention, wherein the water-soluble polymer concerns a polyacrylate or a methacrylic acid-ethyl acrylate copolymer and/or with cellulose ethers, a methyl cellulose (MC), hydroxyethyl cellulose (HEC), hydroxypropyl cellulose (HPC), hydroxypropyl methyl cellulose (HPMC) or carboxymethyl cellulose (CMC).

Indeed, as is shown by the examples of the present application, granulates according to the invention having an additional polymer coating exhibit increased stability values. In practical terms in Example 4, a coating with a commercially available polyacrylate (methacrylic acid-ethyl acrylate copolymer (1:1)) was carried out and demonstrated outstanding stability values. The commercially available polymer Kollicoat MEA from BASF is likewise suitable for this.

A preferred embodiment concerns a coated granulate according to the invention, wherein the coating additionally comprises one or a plurality of fillers, selected from the group of the inorganic particles, preferably silicate or aluminum oxide, particularly preferably talcum.

Fillers of this type can be used for example to influence the plasticity of the coating in question and/or the resulting particles as a whole, to improve their impermeability to diffusion or to regulate the bulk density of the particles.

A preferred embodiment concerns an inventively coated granulate, wherein the coating additionally comprises one or a plurality of plasticizers, selected from the group: triethyl citrate, triacetin, polyhydric alcohols, especially 1,2-propanediol, and polyethylene glycol.

Indeed, as is shown by the examples of the present application, granulates according to the invention having an additional polymer coating exhibit increased stability values. In practical terms in Example 4, a coating was carried out with a commercially available polyacrylate (methacrylic acid-ethyl acrylate copolymer (1:1)) to which had been added an additional fraction of 5% plasticizer (based on the coating polymer). This had a positive effect on the processability of the material and therefore ultimately on the advantageous properties of the resulting coated granulate.

A preferred embodiment concerns an inventively coated granulate, wherein the coating additionally comprises pigment, preferably titanium dioxide.

As described above, pigments inventively yield an improvement in the visual appearance of the granulates and can have an overall positive effect on the plasticity of the respective material. In analogy with this, the scope of the present invention also extends to providing these properties to the coating or the coating material.

A preferred embodiment concerns a coated granulate according to the invention, wherein the coating additionally comprises one or a plurality of compounds acting as antioxidants.

In connection with the present invention where the object was especially to protect ingredients against bleaching agents, i.e. against oxidation, it is sensible and included in the present application to supplement this protective function of the granulate with an additional protection to that performed by the coating. Consequently, it advantageously comprises antioxidants.

Antioxidants per se are known to the person skilled in the art. Thus, it is common practice, for example, to increase the stability of enzymes against oxidative decomposition by using antioxidants: sulfur-containing reducing agents, sodium sulfite and reducing sugars. Other suitable compounds that may be cited here are for example ascorbic acid, tocopherol, gallates, thiosulfate substituted phenols, hydroquinones, pyrocatechols and aromatic amines as well as organic sulfides, polysulfides, dithiocarbamates, phosphites, phosphonates and vitamin E.

A preferred embodiment concerns a coated granulate according to the invention, wherein the coating amounts to 5 to 100 wt. %, preferably 10 to 80 wt. %, particularly preferably 15 to 60 wt. % of the uncoated granulate.

These figures relate to the finished conditioned granulate. At the moment of manufacture, these values can be even slightly different, because granulates, also after their coating are usually subjected to another drying step. This diminishes the water content of both the core as well as the coating, and can thereby produce variations in the ratios of the water contents. For example, this can be the case when comparatively diluted, i.e. especially water-containing enzyme preparations have been incorporated into the core or when it has been coated with an aqueous suspension of a hydrophobic coating material. In the latter case, the water content of the resulting final coating is significantly lower than that of the core.

A preferred embodiment of the present invention concerns an uncoated or coated granulate according to the invention, having an average particle diameter of 100 to 3000 μm, preferably 200 to 2500 μm, particularly preferably 400 to 2000 μm.

This size depends firstly on the manufacturing process, whereby coated granulates generally have a somewhat larger diameter than the uncoated ones. Secondly, it depends on the field of application. Moreover, these size ranges have proven to be advantageous in order to achieve a rapid disintegration and release of the ingredients at the moment when the material in question is used and in addition to lend the product a particularly esthetic impression.

In addition, it is visually more appealing and moreover advantageous in regard to handling and to achieving a constant activity profile, to present the granulate particles with the most uniform possible size distribution, wherein certain variation limits are to be taken into account depending on each manufacturing process. The size of the particles can be regulated by variations of the manufacturing processes known per se to the person skilled in the art for manufacturing the particles, especially for the uncoated particles. Thus, those granulates obtained by extrusion are preferred, in which 90% of all particles are within a range of ±20% of the average size. This can be controlled by means of the die plate.

Thus, those granulates obtained by fluidized bed processes are preferred, in which 90% of all particles are within a range of ±50% of the average size. This can be realized, as is also the case for the extrudates, by sieving.

A preferred embodiment of the present invention concerns an uncoated or coated granulate according to the invention, having an average density of 1.00 to 1.5, preferably from 1.02 to 1.30, particularly preferably from 1.05 to 1.15 g/ml.

Possibilities for regulating the density per se are known to the person skilled in the art and were also already presented above. The regulation of the density according to the invention is advantageous in order to match the density of the intended compositions for use. Accordingly, liquid or gelled compositions (see below) according to the invention comprise granulate particles having practically the same density as the surrounding matrix in order to avoid both sedimentation as well as creaming.

The density of the granulates described in Example 4 of the present application is ca. 1.29 g/ml.

Processes for manufacturing all granulates according to the invention are a further subject matter of the present invention.

Processes for manufacturing granulates of sensitive ingredients of laundry detergent or cleaning compositions per se are known to the person skilled in the art. In this regard, reference is made to the abovementioned handbooks and illustrations. A substantial prior art exists in particular for the manufacture of enzyme granulates.

An advantageous procedure, based on a liquid, concentrated aqueous enzyme preparation can be described thus: The enzyme concentrate is metered in the advantageously previously manufactured, dried, powdery to granular mixture of an invention relevant composition. The water content of the mixture should be chosen such that it allows said mixture to be converted by processing with stirring and striking tools into granular, room temperature-non sticky particles and to be plastically molded and extruded by the use of high pressures. The free-flowing premix is then processed in the in principal known manner in a kneader coupled to an extruder, into a plastic, if possible homogeneous mass, wherein the mass is heated by the mechanical processing to temperatures between 15 and 80° C., particularly 40° C. and 60° C., especially to 45° C. to 55° C. An extrusion temperature is inventively advantageously below 60° C. and an extrusion pressure in the range 30 to 130 bar, especially in the range 50 to 90 bar.

The material leaving the extruder is fed through a die plate coupled to a downstream die cutter and thereby cut into cylindrical particles of a defined size. The diameters of the bores in the die plate are advantageously 0.7 to 1.2 mm, preferably 0.8 to 1.0 mm. It can also be advantageous that the mass coming out of the die plate of the extruder is not immediately cut up at the die head, but rather a cooling path is set up, after which the granulation occurs in a cutting device.

The thus obtained particles can then be dried, rounded and/or coated. It has proved advantageous to spherulize the cylindrical particles leaving the extruder and cutter prior to encapsulation, i.e. round off and debur them in suitable equipment. Equipment consisting of a cylindrical case with stationary, solid side walls and a rotatable, embedded friction plate on the lower side is used for this purpose. This type of equipment is well known in the industry under the trademark Marumerizer® and is described, for example, in DE 2137042 and DE 2137043. The possible dust fractions with a particle size below 0.1 mm, especially below 0.4 mm, as well as the coarse fraction with a particle size above 2 mm, especially above 1.6 mm, can then be removed by sieving or elutriation and optionally recycled into the manufacturing process. After spheronization, the small spheres are continuously or batch wise dried, preferably using a fluidized bed drying unit with entry air temperatures of preferably 35° C. to 70° C. and particularly with a product temperature not exceeding 60° C., to the desired residual moisture content of, for example 2 wt. % to 10 wt. %, in particular 3 wt. % to 8 wt. %, based on the total granulate—if their original water contents were higher.

Processes for coating granulates have already been discussed above. Processes are known from the prior art, in which the coating materials, especially those with a waxy structure (i.e. at melting points above room temperature) are applied in the form of a melt, or those, in which, especially organic coating materials, are applied as a solution in an organic solvent. All these processes are possible realizations of the present invention. However, those are preferred, in which the coating materials are applied in the form of an aqueous solution or suspension, and the excess water is subsequently optionally evaporated. Indeed, in this way the risk of denaturing the enzymes comprised in the granulate particles at elevated temperature or with contact with the solvents in question is avoided. Also, comprised perfumes could be dissolved out of the particles with organic solvents. Also in regard to the protection of the environment, the coating with water as the solvent is preferred.

In connection with the present invention, each of the following process variants, as can be taken from the previous embodiments and also recognized in this description, have been shown to be advantageous and especially when combined with one another:
Inventive process, wherein the adsorbent (b) is present as a predominantly dry substance and the enzyme component (a) is incorporated as a liquid preparation;
inventive process, wherein the binder (c) is incorporated simultaneously with the liquid enzyme component (a), preferably in the form of a premix of both of these components together;
Inventive process, wherein the adsorbent (b) is in a mixer or a fluidized bed unit and the binder (b) and the liquid enzyme component (a) are sprayed on singly or in a previously made mixture, whereby a homogeneous agglomerate is produced;
Inventive process, wherein optionally additionally comprised solids are blended with the adsorbent (b);
Inventive process, wherein optionally additional liquid substances are incorporated as the liquid preparation(s), optionally by mixing or emulsification with one of the other liquid components;
Inventive process, wherein the ingredients are extruded and optionally spheronized and/or optionally coated.

A preferred embodiment concerns a process according to the invention, wherein at least one of the liquid ingredients is separately fed under process conditions during the extrusion process.

This is true for example for a liquid preparation of the incorporatable sensitive ingredient (a), especially a liquid enzyme preparation. It can be metered in through a separate liquid metering unit at any point of the process length of the extruder, whereas the components (b), (c) and (d) are fed at the beginning of the process length as a free flowing granulate or as a powder blend.

In connection with the present invention, each of the following process variants, as can be taken from the previous embodiments and also recognized in this description, have also been shown to be advantageous and especially when combined with one another:
inventive process, wherein the density of the resulting granulate particles is adjusted by adding materials of higher or lower density as additional components of the adsorbent (a) or as further ingredients (d) to average densities of 1.00 to 1.50, preferably from 1.02 to 1.30, particularly preferably from 1.05 to 1.15 g/ml.
inventive process for manufacturing a coated enzyme granulate, wherein in a fluidized bed apparatus the coating material is sprayed from an aqueous solution/suspension onto the particles to be coated;
inventive process for manufacturing a coated enzyme granulate, wherein the total weight of the coating material is 5 to 100 wt. %, preferably 10 to 80 wt. %, particularly preferably 15 to 60 wt. % of the weight of the particles to be coated.

Laundry detergent or cleaning composition, comprising a sensitive ingredient in the form of a granulate according to the invention, form a further subject matter of the present invention.

According to the invention, solid, liquid or gelled laundry detergent and cleaning composition are provided, which comprise sensitive ingredients, especially enzymes having a good protection against other, especially bleaching ingredients. This conditioning form is physically largely stable for exercising its protective function. Having said that, in the application, i.e. in the moment of dilution by the aqueous wash liquor, it shows a good release behavior, such that the enzymes are rapidly available in active form, and leave practically no residue on the washing.

In the context of the present invention, laundry detergent or cleaning composition is understood to mean any imaginable type of cleaning composition, both concentrates as well as compositions to be used without dilution, for use on a commercial scale in washing machines or in hand washing or cleaning. These include, for example, laundry detergents for fabrics, carpets or natural fibers, for which the term “laundry detergent” is used in the present invention. These also include, for example, dishwashing detergents for dishwashing machines or manual dishwashing detergents or cleaners for hard surfaces, such as metal, glass, china, ceramic, tiles, stone, painted surfaces, plastics, wood or leather, for which the term “cleaning composition” is used in the present invention.

Embodiments of the present invention include all types established by the prior art and/or all required presentation forms of the inventive laundry detergent or cleaning composition. These include in particular solid, powdered compositions optionally also from a plurality of phases, compressed or non-compressed; further included are for example: extrudates, granulates, tablets or pouches, both in bulk and also packed in portions.

In addition to granulates, preferably of enzymes (see above), an inventive laundry detergent or cleaning composition optionally comprises further ingredients such as enzyme stabilizers (see above), surfactants, e.g. non-ionic, anionic and/or amphoteric surfactants, and/or bleaching agents, and/or builders, as well as optional further usual ingredients, among which particularly the following are cited: other, especially the already abovementioned enzymes, sequestrants, electrolytes, optical brighteners, graying inhibitors, silver corrosion inhibitors, color transfer inhibitors, foam inhibitors, abrasives, colorants and fragrances, as well as microbials and/or UV absorbents.

There exists an extensive prior art for the manufacture and composition of laundry detergent and/or cleaning compositions, to which reference is made here. The compositions are usually tailored for specific problems that for example relate to soiling, use temperatures and use media or application possibilities. The granulates according to the invention are included in these types of optimizations, for example in regard to their dissolution behavior or adapting the comprised components.

Commensurate with these embodiments, the use of the inventively described granulates as blending components in laundry detergent or cleaning compositions, illustrates a further subject matter of the present invention.

The enzyme granulate according to the invention, or manufactured by the process according to the invention, is used for manufacturing solid, especially particle shaped laundry detergent or cleaning compositions that can be obtained by simple blending of the enzyme granulates with powder components typically used in these types of compositions. For incorporation in particulate laundry detergent and cleaning compositions, the enzyme granulate preferably exhibits a mean particle size in the range 0.7 to 2.0 mm. The granulates according to the invention preferably comprise less than 2 wt. %, especially maximum 1.4 wt. % of particles with particle sizes outside the range of 0.4 to 2.0 mm. However, the process is not limited to these particle sizes, but rather covers a wide particle size spectrum appropriate to the field of application; usually the average particle size diameter (d₅₀) is between 0.1 to more than 2 mm.

In addition to the granulates according to the invention, a laundry detergent or cleaning composition according to the invention comprises surfactant(s), wherein anionic, non-ionic, zwitterionic and/or amphoteric surfactants can be employed. Mixtures of anionic and non-ionic surfactants are preferred from the technical viewpoint. The total surfactant content of the liquid laundry detergent or cleaning composition is preferably below 40 wt. % and particularly preferably below 35 wt. %, based on the total liquid laundry detergent.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably methyl-branched in the 2-position, or may contain linear and methyl-branched groups in the form of the mixtures typically present in oxoalcohol groups. In particular, however, alcohol ethoxylates with linear alcohol groups of natural origin with 12 to 18 carbon atoms, e.g. from coco-, palm-, tallow- or oleyl alcohol, and an average of 2 to 8 EO per mole alcohol are preferred. Exemplary preferred ethoxylated alcohols include C₁₂₋₁₄ alcohols with 3 EO or 4EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, as well as mixtures of C₁₂₋₁₄ alcohol with 3 EO and C₁₂₋₁₈ alcohol with 5 EO.

The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO and PO groups together in the molecule are employable according to the invention. Here, block copolymers with EO-PO blocks or PO-EO blocks can be added, but also EO-PO-EO copolymers or PO-EO-PO copolymers. Of course, mixed alkoxylated non-ionic surfactants can also be used, in which EO- and PO-units are not in blocks but rather distributed statistically. Such products can be obtained by the simultaneous action of ethylene oxide and propylene oxide on fatty alcohols.

Furthermore, as additional non-ionic surfactants, alkyl glycosides that satisfy the general Formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1 and 10, preferably between 1.2 and 1.4. Alkyl glycosides are known, mild surfactants.

Another class of preferred non-ionic surfactants which may be used, either as the sole non-ionic surfactant or in combination with other non-ionic surfactants are alkoxylated, preferably ethoxylated or ethoxylated and propoxylated fatty acid alkyl esters preferably containing 1 to 4 carbon atoms in the alkyl chain, in particular fatty acid methyl esters.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (I),

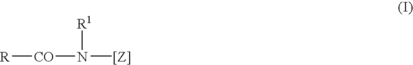

in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the Formula (II),

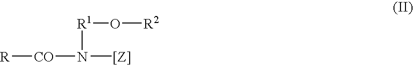

in which R stands for a linear or branched alkyl or alkenyl group containing 7 to 12 carbon atoms, R¹ for a linear, branched or cyclic alkyl group or an aryl group containing 2 to 8 carbon atoms and R² for a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

[Z] is preferably obtained by reductive amination of a sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

The content of non-ionic surfactants in the laundry detergents or cleaning composition is preferably 5 to 30 wt. %, advantageously 7 to 20 wt. % and particularly 9 to 15 wt. %, in each case based on the total laundry detergent or cleaning composition.

In addition to the non-ionic surfactants, the laundry detergent or cleaning composition can also comprise anionic surfactants. Exemplary suitable anionic surfactants are those of the sulfonate and sulfate type. Suitable surfactants of the sulfonate type are, advantageously C₉₋₁₃ alkylbenzene sulfonates, olefin sulfonates, i.e. mixtures of alkene- and hydroxyalkane sulfonates and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g. the α-sulfonated methyl esters of hydrogenated coco-, palm nut- or tallow acids are likewise suitable.

Further suitable anionic surfactants are sulfated fatty acid esters of glycerine. They include the mono-, di- and triesters and also mixtures of them, such as those obtained by the esterification of a monoglycerine with 1 to 3 moles fatty acid or the transesterification of triglycerides with 0.3 to 2 moles glycerine. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali metal and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petrochemical basis and which show similar degradation behavior to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of laundry performance. 2,3-Alkyl sulfates, which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched alcohols with an average of 3.5 mole ethylene oxide (EO) or C₁₂₋₁₈ fatty alcohols with 1 to 4 EO. Due to their high foaming performance, they are only used in fairly small quantities in cleaning compositions, for example in amounts of 1 to 5% by weight.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates comprise C₈₋₁₈ fatty alcohol groups or mixtures of them. Especially preferred sulfosuccinates contain a fatty alcohol group derived from the ethoxylated fatty alcohols that are under consideration as non-ionic surfactants. Once again the particularly preferred sulfosuccinates are those, whose fatty alcohol groups are derived from ethoxylated fatty alcohols with narrow range homolog distribution. It is also possible to use alk(en)ylsuccinic acids with preferably 8 to 18 carbon atoms in the alk(en)yl chain, or salts thereof.

Particularly preferred anionic surfactants are soaps. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

When used in PAP-containing compositions, it has proven advantageous—because of the reactivity of this oxidizing agent—to keep the content of surfactants having mono- and above all poly-unsaturated carbon chains as low as possible.

The anionic surfactants, including the soaps, may be in the form of their sodium, potassium or ammonium salts or as soluble salts of organic bases, such as mono-, di- or triethanolamine. Preferably, the anionic surfactants are in the form of their sodium or potassium salts, especially in the form of the sodium salts.

The content of anionic surfactants in a laundry detergent or cleaning composition is advantageously 0.1 to 30 wt. %, based on the total laundry detergent or cleaning composition.

In addition to the surfactant(s), the laundry detergent or cleaning composition can comprise additional ingredients that further improve the application technological and/or esthetic properties of the laundry detergent or cleaning composition. In the context of the present invention, the laundry detergent or cleaning composition preferably comprises one or a plurality of materials from the group of the builders, bleaches, bleach activators, enzymes, electrolytes, non-aqueous solvents, pH adjustors, perfumes, perfume carriers, fluorescence agents, dyes, hydrotropes, foam inhibitors, silicone oils, anti-redeposition agents, optical brighteners, graying inhibitors, shrink preventers, anti-crease agents, further color transfer inhibitors, antimicrobials, germicides, fungicides, antioxidants, preservatives, corrosion inhibitors, antistats, bitters, ironing aids, water-repellents and impregnation agents, swelling and non-skid agents, neutral filler salts, softening components and UV-absorbers.

The laundry detergent or cleaning composition can also comprise a second, preferably nitrogen-containing, color transfer inhibitor. Examples of the second color transfer inhibitors are: polymers or copolymers of cyclic amines such as for example vinyl pyrrolidone and/or vinylimidazole, polyvinyl pyrrolidone (PVP), polyvinylimidazole (PVI), copolymers of vinyl pyrrolidone and vinylimidazole (PVP/PVI), polyvinyl pyridine-N-oxide, poly-N-carboxymethyl-4-vinylpyridium chloride as well as mixtures of them.

The added polyvinyl pyrrolidones (PVP) preferably have an average molecular weight of 2 500 to 400 000 and are commercially available from ISP Chemicals as PVP K 15, PVP K 30, PVP K 60 or PVP K 90 or from BASF as Sokalan® HP 50 or Sokalan® HP 53.

The added copolymers of vinyl pyrrolidone and vinylimidazole (PVP/PVI) preferably have a molecular weight in the range 5000 to 100 000. A commercially available PVP/PVI copolymer is for example Sokalan® HP 56 from BASF.

The amount of the second color transfer inhibitor, if present, based on the total weight of the laundry detergent or cleaning composition is preferably 0.01 to 10 wt. %, advantageously from 0.05 to 5 wt. % and more preferably from 0.1 to 2 wt. %.

Silicates, aluminum silicates (particularly zeolites), carbonates, salts of organic di- and polycarboxylic acids as well as mixtures of these materials can be particularly cited as builders that can be comprised in the laundry detergent or cleaning composition.

Suitable crystalline, layered sodium silicates correspond to the general formula NaMSiₓO₂ₓ₊₁H₂O, wherein M is sodium or hydrogen, x is a number from 1.9 to 4 and y is a number from 0 to 20, preferred values for x being 2, 3 or 4. Preferred crystalline, layered silicates of the given Formula are those in which M stands for sodium and x assumes the values 2 or 3. In particular, both β- and δ-sodium disilicates Na₂Si₂O₅.yH₂O are preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflections typical of crystalline substances, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. Compacted/densified amorphous silicates, compounded amorphous silicates and over dried X-ray amorphous silicates are particularly preferred.

Of the suitable fine crystalline, synthetic zeolites containing bound water, zeolite A and/or P are preferred. Zeolite MAP® (commercial product of the Crosfield company), is particularly preferred as the zeolite P. However, zeolite X and mixtures of A, X and/or P are also suitable. Commercially available and preferably used in the context of the present invention is, for example, also a co-crystallizate of zeolite X and zeolite A (ca. 80 wt. % zeolite X), which is marketed by the SASOL Company under the trade name VEGOBOND AX® and which can be described by the Formula

nNa₂O(1−n)K₂OAl₂O₃(2−2.5)SiO₂(3.5−5.5)H₂O
n=0.90-1.0

The zeolite can be employed as the spray-dried powder or also as the non-dried, still moist from its manufacture, stabilized suspension. For the case where the zeolite is added as a suspension, this can comprise small amounts of non-ionic surfactants as stabilizers, for example 1 to 3 wt. %, based on the zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have a mean particle size of less than 10 μm (volume distribution, as measured by the Coulter Counter Method) and contain preferably 18 to 22% by weight and more preferably 20 to 22% by weight of bound water.

Naturally, the generally known phosphates can also be added as builders, in so far that their use should not be avoided on ecological grounds. The sodium salts of the orthophosphates, the pyrophosphates and especially the tripolyphosphates are particularly suitable.

Organic builders that can be present in the laundry detergent or cleaning composition are for example the polycarboxylic acids in the form of their sodium salts, wherein polycarboxylic acids are understood to mean those carboxylic acids that have more than one acidic function. These are for example, citric acid, adipic acid, succinic acid, glutaric acid, malic acid, tartaric acid, maleic acid, fumaric acid, sugar acids, amino carboxylic acids, nitrilotriacetic acid (NTA) and their derivatives as well as mixtures of them. Preferred salts are the salts of the polycarboxylic acids such as citric acid, adipic acid, succinic acid, glutaric acid, tartaric acid, sugar acids and mixtures thereof.

The acids per se can also be used. In addition to their builder action, the acids also typically possess the characteristic of an acidifying component and therefore also serve to adjust a lower and milder pH of the laundry detergent or cleaning compositions. In particular, citric acid, succinic acid, glutaric acid, adipic acid, gluconic acid and any mixtures of these may be cited for this.

Polymeric polycarboxylates are also suitable as builders. These are for example the alkali metal salts of polyacrylic acid or of polymethacrylic acid, for example those with a relative molecular weight of 500 to 70 000 g/mol.

The molecular weights mentioned in this specification for polymeric polycarboxylates are weight-average molecular weights Mw of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ distinctly from the molecular weights measured against polystyrene sulfonic acids as the standard. The molecular weights measured against polystyrene sulfonic acids are generally significantly higher than the molecular weights mentioned in this specification.

Particularly suitable polymers are polyacrylates, which preferably have a molecular weight of 2000 to 20 000 g/mol. By virtue of their superior solubility, preferred representatives of this group are again the short-chain polyacrylates, which have molecular weights of 2000 to 10 000 g/mol and, more particularly, 3000 to 5000 g/mol.

Suitable polymers can also include substances that consist partially or totally of units of vinyl alcohol or derivatives thereof.

Also suitable are copolymeric polycarboxylates, particularly those of acrylic acid with methacrylic acid and those of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weights, based on the free acids, are generally in the range from 2000 to 70 000 g/mol, preferably in the range from 20 000 to 50 000 g/mol and more preferably in the range from 30 000 to 40 000 g/mol. The (co)polymeric polycarboxylates may be used either as an aqueous solution or preferably in powder form.

In order to improve the water solubility, the polymers can also comprise allyl sulfonic acids such as allyloxybenzene sulfonic acid and methallyl sulfonic acid as the monomer.

Other particularly preferred polymers are biodegradable polymers of more than two different monomer units, for example those which contain salts of acrylic acid and maleic acid as well as vinyl alcohol or vinyl alcohol derivatives as monomers or those which contain salts of acrylic acid and 2-alkylallyl sulfonic acid and sugar derivatives as monomers.

Other preferred copolymers are those, which preferably contain acrolein and acrylic acid/acrylic acid salts or acrolein and vinyl acetate as monomers.

As other preferred builders may be cited polymeric amino dicarboxylic acids, salts or precursors thereof. Polyaspartic acids or salts and derivatives thereof, which have a bleach stabilizing effect besides their builder properties, are particularly preferred.

Further suitable builders are polyacetals, which may be obtained by reaction of dialdehydes with polyol carboxylic acids containing 5 to 7 carbon atoms and at least three hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Other suitable organic builders are dextrins, for example oligomers or polymers of carbohydrates, which may be obtained by partial hydrolysis of starches. The hydrolysis may be carried out by standard methods, for example acid- or enzyme-catalyzed methods. The end products are preferably hydrolysis products with average molecular weights of 400 to 500 000 g/mol. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose syrups with a DE of 20 to 37 and also so-called yellow dextrins and white dextrins with relatively high molecular weights of 2000 to 30 000 g/mol may be used.

The oxidized derivatives of such dextrins are their reaction products with oxidizing agents that are capable of oxidizing at least one alcohol function of the saccharide ring to the carboxylic acid function. Also suitable is an oxidized oligosaccharide. A product that is oxidized at the C6 of the saccharide ring can be particularly advantageous.

Other suitable co-builders are oxydisuccinates and other derivatives of disuccinates, preferably ethylenediamine disuccinate. Ethylenediamine-N,N′-disuccinate (EDDS) is preferably used in the form of its sodium or magnesium salts. Glycerol disuccinates and glycerol trisuccinates are also preferred in this connection.

Other useful organic co-builders are, for example, acetylated hydroxycarboxylic acids and salts thereof which may optionally be present in lactone form and which contain at least 4 carbon atoms, at least one hydroxyl group and at most two acid groups.

Builders such as citric acid/citrates, polycarboxylates and phosphonates are particularly suitable for liquid formulations and are accordingly particularly preferred in the context of the present invention.

Among the compounds, which serve as bleaching agents and liberate H₂O₂ in water, sodium perborate tetrahydrate and sodium perborate monohydrate are of particular importance. Examples of additional bleaching agents that may be employed are peroxypyrophosphates, citrate perhydrates and H₂O₂-liberating peracidic salts or peracids, such as persulfates or persulfuric acid. The urea peroxyhydrate percarbamide that can be described by the formula H₂N—CO—NH₂.H₂O₂ is also suitable. Particularly when the compositions are used to clean hard surfaces, for example in automatic dishwashers, they can, if desired, also comprise bleaching agents from the group of the organic bleaching agents, although in principal they can also be used for washing textiles. Typical organic bleaching agents are diacyl peroxides, such as dibenzoyl peroxide for example. Other typical organic bleaching agents are the peroxy acids, of which alkyl peroxy acids and aryl peroxy acids are particularly mentioned as examples. Preferred representatives are peroxybenzoic acid and ring-substituted derivatives thereof, such as alkyl peroxybenzoic acids, but also peroxy α-naphthoic acid and magnesium monoperphthalate, the aliphatic or substituted aliphatic peroxy acids, such as peroxylauric acid, peroxystearic acid, ε-phthalimidoperoxycaproic acid (phthaloiminoperoxyhexanoic acid PAP), o-carboxybenzamidoperoxycaproic acid, N-nonenylamidoperadipic acid and N-nonenylamido persuccinates and aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic acid).

Perborate monohydrate, percarbonate or PAP are particularly advantageously used, preferably PAP.

Other suitable bleaching agents are chlorine- and bromine-releasing substances. Among the suitable chlorine- or bromine-releasing materials are, for example, heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

The content of bleaching agent in the composition can be 0.1 to 40 wt. %, preferably 0.5 to 30 wt. %, particularly preferably 1 to 25 wt. % and especially 2 to 20 wt. %. The active oxygen content of the laundry detergent or cleaning compositions, particularly dishwasher detergents, based on the total weight of the composition, preferably ranges between 0.3 and 15 wt. %, particularly preferably between 0.5 and 10 wt. % and particularly between 0.6 and 8 wt. %, for example 5 wt. %. Particularly preferred agents possess an active oxygen content above 0.7 wt. %, particularly preferably above 0.8 wt. % and particularly above 1.0 wt. %. PAP as a particularly suitable bleaching agent possesses with only ca, 5% active oxygen content, is however so reactive that PAP contents of 1 to 5 wt. %, preferably 2 to 4 wt. %, particularly preferably 2.5 to 3 wt. %, based on the total formulation, are inventive.

The laundry detergents or cleaning compositions can comprise bleach activators in order to achieve an improved bleaching action for washing temperatures of 60° C. and below. Bleach activators, which can be used, are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular 1,3,4,6-tetraacetyl glycoluril (TAGU), N-acylimides, in particular N-nonanoyl succinimide (NOSI), acylated phenolsulfonates, in particular n-nonanoyl- or isononanoyloxybenzene sulfonate (n- or iso-NOBS), acylated hydroxycarboxylic acids, such as triethyl-O-acetyl citrate (TEOC), carboxylic acid anhydrides, in particular phthalic anhydride, isatoic acid anhydride and/or succinic anhydride, carboxylic acid amides, such as N-methyldiacetamide, glycolide, acylated polyhydric alcohols, in particular triacetin, ethylene glycol diacetate, isopropenyl acetate and 2,5-diacetoxy-2,5-dihydrofuran and the enol esters known from the German patent applications DE 196 16 693 and DE 196 16 767 as well as acetylated sorbitol and mannitol or their mixtures described in the European patent application EP 0 525 239 (SORMAN), acylated sugar derivatives, especially penta acetyl glucose (PAG), pentaacetyl fructose, tetraacetyl xylose and octaacetyl lactose as well as acetylated, optionally N-alkylated glucamine and gluconolactone, triazole or triazole derivatives and/or particulate caprolactams and/or caprolactam derivatives, preferably N-acylated lactams, for example N-benzoyl caprolactam and N-acetyl caprolactam. Hydrophilically substituted acyl acetals and acyl lactams are also preferably used. Combinations of conventional bleach activators may also be used. Nitrile derivatives such as cyanopyridines, nitrilequats, for example N-alkyl ammonium acetonitrile, and/or cyanamide derivatives can also be used. Preferred bleach activators are sodium 4-(octanoyloxy)benzene sulfonate, n-nonanoyl- or isononanoyloxybenzene sulfonate (n- or iso-NOBS), undecenoyloxybenzene sulfonate (UDOBS), sodium dodecanoyloxybenzene sulfonate (DOBS), decanoyloxybenzoic acid (DOBA, OBC 10) and/or dodecanoyloxybenzene sulfonate (OBS 12), and N-methylmorpholinum acetonitrile (MMA).

Such bleach activators can be comprised in the usual amount range of 0.01 to 20 wt. %, preferably in amounts of 0.1 to 15 wt. %, especially 1 wt. % to 10 wt. %, based on the total composition.

In the context of the present application, further preferred added bleach activators are compounds from the group of cationic nitriles, particularly cationic nitriles of the Formula

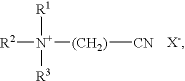

in which R¹ stands for —H, —CH₃, a C₂₋₂₄ alkyl or alkenyl group, a substituted C₂₋₂₄ alkyl or alkenyl group having at least one substituent from the group of —Cl, —Br, —OH, —NH₂, —CN, an alkylaryl or alkenylaryl group having a C₁₋₂₄ alkyl group or for a substituted alkylaryl or alkenylaryl group having a C₁₋₂₄ alkyl group and at least one further substituent on the aromatic ring, R² and R³ independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion.

A cationic nitrile of the following Formula is particularly preferred

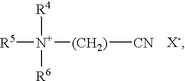

in which R⁴, R⁵ und R⁶ independently of one another are selected from —CH₃, —CH₂—CH₃, —CH₂—CH₂—CH₃, —CH(CH₃)—CH₃, wherein R⁴ can also be —H and X is an anion, wherein preferably R⁵=R⁶=—CH₃ and in particular R⁴=R⁵=R⁶=—CH₃ and compounds of the formulae (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻, or (HO—CH₂—CH₂)₃N⁽⁺⁾CH₂—CNX⁻ are particularly preferred, wherein once again from the group of these substances the cationic nitrile of the formula (CH₃)₃N⁽⁺⁾CH₃X⁻, in which X⁻ stands for an anion selected from the group chloride, bromide, iodide, hydrogen sulfate, methosulfate, p-toluene sulfonate (tosylate) or xylene sulfonate is particularly preferred.

In addition to, or instead of the conventional bleach activators, so-called bleach catalysts may also be incorporated into the laundry detergents or cleaning agents. These substances are bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands and cobalt-, iron-, copper- and ruthenium-ammine complexes may also be used as bleach catalysts.

Complexes of manganese in the valence state II, III, IV or V are particularly preferably employed, which preferably comprise one or a plurality of macrocyclic ligands with the donor functions N, NR, PR, O and/or S. Ligands having nitrogen donor functions are preferably employed. In this regard, it is particularly preferred to incorporate bleach catalysts into the compositions according to the invention, which comprise 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN) as the macromolecular ligands. Suitable manganese complexes are for example [Mn^{III}2(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)S, [Mn^{IV}₂(μ-O)₃(Me-TACN)₂](PF₆)₂ and [Mn^{IV}₂(μ-O)₃(Me/Me-TACN)₂](PF₆)₂ (OAc=OC(O)CH₃).

Bleach catalysts can be added in usual amounts, preferably in an amount of 0.0025 wt. % to 1 wt. %, particularly preferably from 0.01 to 0.25 wt. %, each based on the total weight of the bleach activator-containing composition. In specific cases, however, more bleach catalyst can also be added.

It can also be preferred that the laundry detergent or cleaning composition is a (“2 in 1”) softening laundry detergent or cleaning composition. For this purpose the laundry detergent or cleaning composition also comprises a softening component in addition to the color transfer inhibitor and the surfactants.

The softening component includes for example ammonium compounds such as monoalk(en)yltrimethylammonium compounds, dialk(en)yldimethylammonium compounds, mono-, di- or triesters of fatty acids with alkanolamines.

Suitable examples of quaternary ammonium compounds are for example shown in the formulae (III) and (IV):

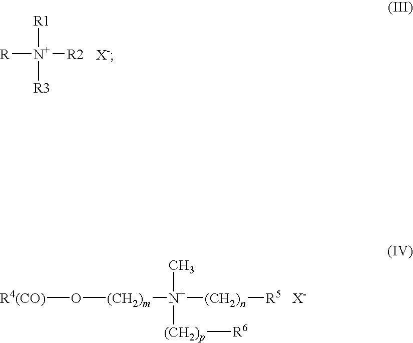

in which in (III) R stands for an acyclic alkyl group with 12 to 24 carbon atoms, R¹ for a saturated C₁-C₄ alkyl or hydroxyalkyl group, R² and R³ are either the same as R or R¹ or stand for an aromatic group. X⁻ stands either for a halide-, methosulfate-, methophosphate- or phosphate ion as well as mixtures of them. Examples of cationic compounds of Formula (III) are monotallowtrimethyl ammonium chloride, monostearyltrimethylammonium chloride, didecyldimethylammonium chloride, ditallowedimethylammonium chloride or dihexadecylammonium chloride.

Compounds of the Formula (IV), (V) and (VI) are so called esterquats. Esterquats are characterized by their outstanding biodegradability. In Formula (IV) R⁴ stands for an aliphatic alk(en)yl group with 12 to 22 carbon atoms with 0, 1, 2 or 3 double bonds and/or optionally with substituents; R⁵ stands for H, OH or O(CO)R⁷, R⁶ stands independently of R⁵ for H, OH or O(CO)R⁸, wherein R⁷ and R⁸ independently of one another each stands for an aliphatic alk(en)yl group with 12 to 22 carbon atoms with 0, 1, 2 or 3 double bonds, m, n and p each independently of one another can have the value 1, 2 or 3. X⁻ can be either a halide-, methosulfate-, methophosphate- or phosphate ion as well as mixtures of these anions. Compounds are preferred in which R⁵ represents the group O(CO)R⁷. Particularly preferred compounds are compounds in which R⁵ represents the group O(CO)R⁷ and R⁴ and R⁷ are alk(en)yl groups with 16 to 18 carbon atoms. Compounds in which R⁶ in addition stands for OH are especially preferred. Examples of compounds of Formula (IV) are methyl-N-(2-hydroxyethyl)-N,N-di(tallowacyloxyethyl)ammonium methosulfate, bis-(palmitoyloxyethyl)-hydroxyethyl-methyl-ammonium methosulfate, 1,2-bis-[tallowacyloxy]-3-trimethylammoniumpropane chloride or methyl-N,N-bis(stearoyloxyethyl)-N-(2-hydroxyethyl)ammonium methosulfate.

When quaternized compounds of Formula (IV) are used that have unsaturated alkyl chains, the acyl groups are preferred, whose corresponding fatty acids have an iodine number between 1 and 100, preferably between 5 and 80, more preferably between 10 and 60 and particularly between 15 and 45 and which have a cis/trans isomer ratio (in wt. %) of greater than 30:70, preferably greater than 50:50 and particularly greater than 60:40. Commercial examples are the methyl-hydroxyalkyl-dialkoyloxyalkylammonium methosulfates marketed by the Stepan company under the trade name Stepantex® or known products from Cognis with the tradename Dehyquart® or the known products manufactured by Degussa under the name Rewoquat® or the known products from Kao under the name Tetranyl®. Further preferred compounds are the diesterquats of Formula (V), which are available under the names Rewoquat® W222 LM and CR 3099.

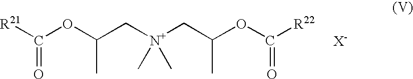

In this case, R²¹ and R²² each stand independently of one another for an aliphatic group with 12 to 22 carbon atoms with 0, 1, 2 or 3 double bonds.

Instead of the ester group O(CO)R, wherein R stands for a long chain alk(en)yl group, softening compounds can be added, which possess the following groups: RO(CO), N(CO)R or RN(CO), wherein the N(CO)R groups are preferred among these groups.

In addition to the above described quaternary compounds, other compounds can also be employed as softening components, such as, for example quaternary imidazolinium compounds of Formula (VI),

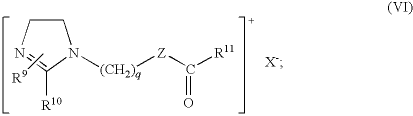

wherein R⁹ stands for H or a saturated alkyl group with 1 to 4 carbon atoms, R¹⁰ and R¹¹, independently of one other, each stand for an aliphatic, saturated or unsaturated alkyl group with 12 to 18 carbon atoms, R¹⁰ can alternatively stand for O(CO)R²⁰, wherein R²⁰ means an aliphatic, saturated or unsaturated alkyl group with 12 to 18 carbon atoms, and Z means an NH group or oxygen and X⁻ is an anion. q can take values of integers between 1 and 4.

Further particularly preferred esterquats are described by the Formula (VII),

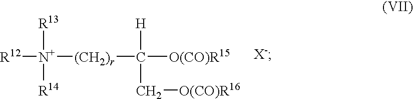

wherein R¹², R¹³ and R¹⁴ independently of one another stand for a C₁₋₄ alkyl, alkenyl or hydroxyalkyl group, R¹⁵ and R¹⁶, each independently selected, represents a C₈₋₂₈ alkyl group, X⁻ is an anion and r is a number between 0 and 5. A preferred example of a cationic precipitation aid according to Formula (VII) is 2,3-bis[tallowacyloxy]-3-trimethylammonium propane chloride.

Further suitable softening components according to the invention are illustrated by quaternized protein hydrolyzates or protonated amines.

In addition, cationic polymers are also suitable softening components. Suitable cationic polymers include the polyquaternium polymers such as those in the CTFA Cosmetic Ingredient Dictionary (The Cosmetic, Toiletry and Fragrance, Inc., 1997), particularly those polyquaternium-6, polyquaternium-7, polyquaternium-10 polymers also described as Merquats (Polymer JR, LR and KG series from Amerchol), polyquaternium-4-copolymers, such as graft copolymers with a cellulosic backbone and quaternary ammonium groups that are bonded through allyl dimethyl ammonium chloride, cationic cellulose derivatives like cationic guar, such as guar hydroxypropyl triammonium chloride, and similar quaternized guar derivatives (e.g. Cosmedia Guar, manufactured by Cognis or the Jaguar series from Rhodia), cationic quaternary sugar derivatives (cationic alkyl polyglucosides), e.g. the commercial product Glucquat® 100, according to CTFA nomenclature a “Lauryl Methyl Gluceth-10 Hydroxypropyl Dimonium Chloride”, copolymers of PVP and dimethylamino methacrylate, copolymers of vinyl imidazole and vinyl pyrrolidone, amino silicone polymers and copolymers.

Polyquaternized polymers (e.g. Luviquat® Care from BASF) and also cationic biopolymers based on chitin and its derivatives, for example the polymer obtained under the trade name Chitosan® (manufacturer: Cognis) can also be employed.

Some of the cited cationic polymers additionally exhibit skin caring and/or textile caring properties.

Compounds of Formula (VIII) are likewise suitable,

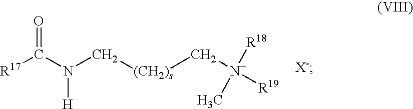

R¹⁷ can be an aliphatic alk(en)yl group having 12 to 22 carbon atoms with 0, 1, 2 or 3 double bonds, s can assume values between 0 and 5. R¹⁸ and R¹⁹ each stand, independently of one another, for H, C₁₋₄ alkyl or hydroxyalkyl and X⁻ is an anion.

Further suitable softening components include protonated or quaternized polyamines.

Alkylated quaternary ammonium compounds having at least one alkyl chain interrupted by an ester group and/or an amido group, are particularly preferred softening components. N-methyl-N-(2-hydroxyethyl)-N,N-(ditallowacyloxyethyl) ammonium methosulfate or bis-(palmitoyloxyethyl)-hydroxyethyl-methyl-ammonium methosulfate are quite particularly preferred.

The laundry detergent or cleaning composition can comprise a thickener. The thickener can include, for example a polyacrylate thickener, Xanthane gum, gellan gum, guar nut flour, alginate, carragheenan, carboxymethyl cellulose, bentonite, wellan gum, locust bean flour, agar-agar, traganth, gummi arabicum, pectins, polyoses, starches, dextrins, gelatines and casein. Modified natural products, such as modified starches and celluloses, examples being carboxymethyl cellulose and other cellulose ethers, hydroxyethyl and hydroxypropyl cellulose as well as bean flour ether, can also be employed as the thickener.

The polyacrylic and polymethacrylic thickeners include, for example, the high molecular weight homopolymers of acrylic acid, crosslinked with a polyalkenyl polyether, in particular an allyl ether of saccharose, pentaerythritol or propylene (INCI name according to the “International Dictionary of Cosmetic Ingredients” of The Cosmetic, Toiletry and Fragrance Association (CTFA): Carbomer), which are also called carboxyvinyl polymers. Such polyacrylic acids are available inter alia from the Company 3V Sigma under the trade name Polygel®, for example Polygel DA, and from the Company Noveon (previously B.F. Goodrich) under the tradename Carbopol®, for example Carbopol 940 (molecular weight ca. 4 000 000), Carbopol 941 (molecular weight ca. 1 250 000) or Carbopol 934 (molecular weight ca. 3 000 000). In addition, the following acrylic acid copolymers fall in this category: (i) copolymers of two or more monomers from the group of acrylic acid, methacrylic acid and their simple esters, preferably formed with C₁₋₄ alcohols, (INCI Acrylates Copolymer), to which belong, for example, the copolymers of methacrylic acid, butyl acrylate and methyl methacrylate (CAS number according to Chemical Abstracts Service: 25035-69-2) or of butyl acrylate and methyl methacrylate (CAS 25852-37-3) and which are available, for example, from Rohm & Haas under the trade names Aculyn® and Acusol®, and from Degussa (Goldschmidt) under the trade names Tego® Polymer, e.g. the anionic non-associative polymers Aculyn 22, Aculyn 28, Aculyn 33 (crosslinked), Acusol 810, Acusol 820, Acusol 823 and Acusol 830 (CAS 25852-37-3); (ii) crosslinked high molecular weight acrylic acid copolymers that include, for example copolymers of C₁₀₋₃₀ alkyl acrylates and one or more monomers from the group of acrylic acid, methacrylic acid and their simple esters, preferably formed with C₁₋₄ alcohols, which are crosslinked with an allyl ether of saccharose or of pentaerythritol (INCI Acrylates/C₁₀₋₃₀ Alkyl Acrylate Crosspolymer) and which are available from the Noveon Company (formally B.F. Goodrich) under the trade name Carbopol®, e.g. the hydrophobized Carbopol ETD 2623 and Carbopol 1382 (INCI Acrylates/C₁₀₋₃₀ Alkyl Acrylate Crosspolymer) as well as Carbopol Aqua 30 (previously Carbopol EX 473).

A further preferred employable polymeric thickener is Xanthane gum, a microbial anionic heteropolysaccharide that is produced under aerobic conditions by Xanthomonas campestris and some other species, and which has a molecular weight of 2 to 15 million Dalton. Xanthane is formed from a chain of linked β-1,4-glucose (cellulose) with side chains. The composition of the sub-groups consists of glucose, mannose, glucuronic acid, acetate and Pyruvate, wherein the number of pyruvate units determines the viscosity of the Xanthane gum.

A fatty alcohol can also be considered as a thickener. Fatty alcohols can be branched or unbranched and of natural origin or of petrochemical origin. Preferred fatty alcohols have a carbon chain length of 10 to 20 carbon atoms, preferably 12 to 18. Mixtures of different carbon chain lengths, such as tallow fatty alcohol or coco fatty alcohol are preferably employed. Examples are Lorol® Spezial (C₁₂₋₁₄ ROH) or Lorol® Technisch (C₁₂₋₁₈ ROH) (both from Cognis).

A further class of thickeners are silcate-like particles, such as for example those offered under the trade name Optigel or Thixogel (Südchemie) or also silicic acid. Optigel WX (Südchemie) is particularly preferred.

The laundry detergent or cleaning composition can comprise 0.01 to 3 wt. % and preferably 0.1 to 1 wt. % thickener. The quantity of added thickener depends on the type of thickener and the desired degree of thickening.

The laundry detergent or cleaning composition can further comprise, even non-inventively granulated enzymes. Suitable enzymes are, in particular, those from the classes of the hydrolases, such as the proteases, esterases, lipases or lipolytic enzymes, amylases, cellulases or other glycosyl hydrolases, hemicellulases, cutinases, β-glucanases, oxidases, peroxidases, perhydrolases and/or laccases and mixtures of the cited enzymes. In the wash, all these hydrolases contribute to the removal of stains such as protein, fat or starchy stains and against graying. Moreover, cellulases and other glycosyl hydrolases can contribute to increased softness of the textile and to color retention by removing pilling and micro fibrils. Oxidoreductases can also be added to the bleaches or to inhibit the color transfer. Enzymatic active materials obtained from bacterial sources or fungi such as bacillus subtilis, bacillus licheniformis, streptomyceus griseus and humicola insolens are particularly well suited. Proteases of the subtilisin type and particularly proteases that are obtained from bacillus lentus, are preferably used. Here, mixtures of enzymes are of particular interest, for example of protease and amylase or protease and lipase or lipolytic enzymes or protease and cellulase or cellulase and lipase or lipolytic enzymes or protease, amylase and lipase or lipolytic enzymes or protease, lipase or lipolytic enzymes and cellulase, in particular, however protease and/or lipase-containing mixtures or mixtures with lipolytic enzymes. Examples of such lipolytic enzymes are the known cutinases. Peroxidases or oxidases have also proved to be suitable in certain cases. The suitable amylases particularly include α-amylases, iso-amylases, pullulanases and pectinases. Cellobiohydrolases, endoglucanases and β-glucosidases, which are also known as cellobiases, or mixtures thereof, are preferred cellulases. As the different cellulase types differ in their CMCase- and avicelase activities, the required activities can be adjusted by means of controlled mixtures of the cellulases.

The enzymes can be encapsulated or adsorbed on carriers in order to protect them against premature decomposition. The content of the enzymes, the liquid enzyme formulations or the enzyme granules in a laundry detergent or cleaning composition can be, for example, about 0.01 to 5% by weight, preferably 0.12 to about 3.5% by weight.

A large number of the most varied salts from the group of the inorganic salts can be employed as the electrolytes. Preferred cations are the alkali metal and alkaline earth metals, preferred anions are the halides and sulfates. The content of electrolytes in the laundry detergent or cleaning composition normally ranges from 0.1 to 5 wt. %.

Non-aqueous solvents that can be added to the laundry detergent or cleaning composition originate for example from the group of the mono- or polyhydric alcohols, alkanolamines or glycol ethers, in so far as they are miscible with water in the defined concentration range. Preferably, the solvents are selected from ethanol, n- or i-propanol, butanols, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, dipropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether, di-n-octyl ether as well as mixtures of these solvents. Non-aqueous solvents can be added to the laundry detergent or cleaning composition in amounts between 0.5 and 15 wt. %, preferably, however below 12 wt. % and particularly below 9 wt. %.

The addition of pH adjustors can be considered for bringing the pH of the inventive composition into the desired range. Any known acid or alkali can be added, in so far as their addition is not forbidden on technological or ecological grounds or grounds of protection of the consumer. Usually, the amount of this adjustor does not exceed more than 10 wt. % of the total formulation.

The pH of the laundry detergent or cleaning composition is normally between 3 and 7, preferably between 3.5 and 6.5, particularly preferably between 4.0 and 5.5.

In a preferred embodiment, the laundry detergent or cleaning composition comprises one or a plurality of (optionally additional) perfumes, normally in an amount of up to 10 wt. %, preferably 0.01 to 5 wt. %, particularly 0.3 to 3 wt. %. Here, in principle, all perfumes known in the prior art for this field of application can be considered, especially the perfumes already described above as inventively conditionable. Suitable perfume oils or fragrances include individual perfume compounds, for example synthetic products of the ester, ether, aldehyde, ketone, alcohol and hydrocarbon type. Mixtures of various odoriferous substances, which together produce an attractive fragrant note, are particularly preferred. Such perfume oils can also comprise natural mixtures of odoriferous compounds, as are available from vegetal sources.

In order to enhance the esthetic impression of the laundry detergent or cleaning composition, they can be colored with appropriate colorants. Preferred colorants, which are not difficult for the expert to choose, have high storage stability, are not affected by the other ingredients of the laundry detergent or by light and do not have any pronounced substantivity for textile fibers, so as not to color them. Phthalocyanine colorants are particularly suitable for this.

Soaps, paraffins or silicone oils, optionally deposited on carrier materials, are examples of foam inhibitors that can be incorporated into the laundry detergent or cleaning compositions.

Suitable anti-redeposition agents, also referred to as soil repellents, are for example non-ionic cellulose ethers such as methyl cellulose and methyl hydroxypropyl cellulose with a content of methoxy groups of 15 to 30 wt. % and hydroxypropyl groups of 1 to 15 wt. %, each based on the non-ionic cellulose ether, as well as polymers of phthalic acid and/or terephthalic acid or their derivatives known from the prior art, particularly polymers of ethylene terephthalates and/or polyethylene- and/or polypropylene glycol terephthalates or anionically and/or non-ionically modified derivatives thereof. Suitable derivatives include the sulfonated derivatives of the phthalic acid polymers and the terephthalic acid polymers.

Optical brighteners (so called “whiteners”) can be added to the laundry detergent compositions in order to eliminate graying and yellowing of the treated textile fabrics. These materials absorb onto the fiber and effect a brightening and pseudo bleach effect in that the invisible ultraviolet radiation is converted into visible radiation, wherein the ultraviolet light absorbed from sunlight is irradiated away as weak blue fluorescence and results in pure white for the yellow shade of the grayed or yellowed washing. Suitable compounds derive for example from the substance classes of 4,4′-diamino-2,2′-stilbenedisulfonic acids (flavonic acids), 4,4′-distyrylbiphenylene, methylumbelliferone, coumarone, dihydroquinolinones, 1,3-diarylpyrazolines, naphthoic acid imides, benzoxazole-, benzisoxazole- and benzimidazole-systems as well as heterocyclic substituted pyrene derivatives. The optical brighteners are usually added in amounts between 0% and 0.3 wt. %, based on the finished laundry detergent or cleaning composition.

Graying inhibitors have the function of maintaining the dirt that was removed from the fibers suspended in the washing liquor, thereby preventing the dirt from resettling. Water-soluble colloids of mostly organic nature are suitable for this, for example glue, gelatines, salts of ether sulfonic acids of starches or celluloses, or salts of acidic sulfuric acid esters of celluloses or starches. Water-soluble, acid group-containing polyamides are also suitable for this purpose. In addition, soluble starch preparations and others can be used as the abovementioned starch products, for example degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl cellulose and mixed ethers such as methyl hydroxyethyl cellulose, methyl hydroxypropyl cellulose, methyl carboxymethyl cellulose and mixtures thereof, which can be added, for example in amounts of 0.1 to 5 wt. %, based on the total amount of laundry detergent or cleaning composition.

As textile fabrics, particularly of rayon, spun rayon, cotton and their mixtures tend to crease because the individual fibers are sensitive to flection, bending, pressing and squeezing at right angles to the fiber direction, the laundry detergent or cleaning composition can comprise synthetic anti-crease agents. They include for example synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

The laundry detergents or cleaning agents can comprise antimicrobial agents to control microorganisms. Depending on the antimicrobial spectrum and the mechanism of action, antimicrobial agents are differentiated as bacteriostatic agents and bactericides, fungistatic agents and fungicides, etc. Important representatives of these groups are, for example, benzalkonium chlorides, alkylaryl sulfonates, halophenols and phenol mercuric acetate, wherein these compounds can also be totally dispensed with in the inventive laundry detergent or cleaning compositions.

The inventive laundry treatment compositions can comprise preservatives, wherein preferably only those are used, which have no or only a slight skin sensitizing potential. Examples are sorbic acid and its salts, benzoic acid and its salts, salicylic acid and its salts, phenoxyethanol, 3-iodo-2-propynylbutyl carbamate, sodium N-(hydroxymethyl)glycinate, biphenyl-2-ol as well as mixtures thereof. A suitable preservative is illustrated by the solvent-free, aqueous combination of diazolidinyl urea, sodium benzoate and potassium sorbate (obtainable as Euxyl® K 500 ex Schuelke & Mayr), which can be employed in a pH range up to 7.

The laundry treatment compositions can comprise antioxidants in order to prevent undesirable changes caused by oxygen and other oxidative processes to the laundry treatment compositions and/or the treated textile fabrics. This class of compounds includes, for example, substituted phenols, hydroquinones, pyrocatechols and aromatic amines as well as organic sulfides, polysulfides, dithiocarbamates, phosphites, phosphonates and vitamin E.

An increased wear comfort can result from the additional use of antistats that can be included in the laundry detergents or cleaning compositions. Antistats increase the surface conductivity and thereby allow an improved discharge of built-up charges. Generally, external antistats are substances with at least one hydrophilic molecule ligand and provide a more or less hygroscopic film on the surfaces. These mainly interface-active antistats can be subdivided into nitrogen-containing (amines, amides, quaternary ammonium compounds), phosphorus-containing (phosphoric acid esters) and sulfur-containing (alkyl sulfonates, alkyl sulfates) antistats. Lauryl (or stearyl) dimethyl benzyl ammonium chlorides are suitable antistats for textile fabrics or as additives to laundry treatment compositions, resulting in an additional finishing effect.

Silicone derivatives, for example, can be incorporated in the laundry treatment compositions to improve the re-wettability of the treated textile fabrics and to facilitate ironing of the treated textile fabrics. By their foam-inhibiting properties, they additionally improve the final rinse behavior of the laundry detergent or cleaning compositions. Exemplary preferred silicone derivatives are polydialkylsiloxanes or alkylarylsiloxanes, in which the alkyl groups possess one to five carbon atoms and are totally or partially fluorinated. Preferred silicones are polydimethylsiloxanes that can be optionally derivatized and then are aminofunctional or quaternized or possess Si—OH, Si—H and/or Si—Cl bonds. The viscosities of the preferred silicones at 25° C. are in the range between 100 and 100 000 mPas, wherein the silicones can be added in amounts between 0.2 and 5 wt. % based on the total amount of laundry detergent or cleaning composition.

Finally, the laundry detergent or cleaning composition can also comprise UV absorbers that are absorbed on the treated textile fabrics and improve the light stability of the fibers. Compounds, which possess these desired properties, are for example, the efficient radiationless deactivating compounds and derivatives of benzophenone having substituents in position(s) 2 and/or 4. Also suitable are substituted benzotriazoles, acrylates, which are phenyl-substituted in position 3 (cinnamic acid derivatives), optionally with cyano groups in position 2, salicylates, organic Ni complexes, as well as natural substances such as umbelliferone and the endogenous urocanic acid.

Substances can be added to complex heavy metals in order to prevent heavy metal catalyzed decomposition of certain laundry detergent ingredients. Suitable heavy metal sequestrants are, for example, the alkali salts of ethylene diamine tetra acetic acid (EDTA) or of nitrilotriacetic acid (NTA) as well as alkali metal salts of anionic polyelectrolytes such as polyacrylates, polymaleates and polysulfonates.

A preferred class of sequestrants are the phosphonates that are comprised in the laundry detergent or cleaning composition in amounts of 0.01 to 2.5 wt. %, preferably 0.02 to 2 wt. % and particularly 0.03 to 1.5 wt. %. These preferred compounds particularly include organophosphonates such as for example 1-hydroxyethane-1,1-diphosphonic acid (HEDP), aminotri(methylenephosphonic acid) (ATMP), diethylenetriamine penta(methylenephosphonic acid) (DTPMP or DETPMP) as well as 2-phosphonobutane-1,2,4-tricarboxylic acid (PBS-AM), which are mainly added in the form of their ammonium or alkali metal salts.

The laundry detergent or cleaning composition according to the invention can be used for washing and/or cleaning textile fabrics, particularly colored textile fabrics.

For manufacturing the laundry detergent or cleaning composition according to the invention, a basic formulation is first manufactured using known methods and processes, in which the ingredients of the basic formulation are simply blended in a stirring vessel, water, non-aqueous solvent and surfactants being advantageously present, and the additional ingredients, fatty alkyldialkylhydroxyethyl-ammonium salt as the color transfer inhibitor, are added portion wise. A special heating during the manufacture is not necessary, but if desired, the temperature of the mixture should not exceed 80° C.

A preferred embodiment of this subject matter of the invention concerns a laundry detergent or cleaning composition that is predominantly liquid, gelled or pasty and preferably contains water.

The inventive, bleaching agent-containing liquid or gelled compositions preferably concern heavy-duty detergents for cleaning textiles, which are perceived by the consumer as having an esthetic flow behavior and/or are well manufactured.

Preferred embodiments of this subject matter of the invention concern inventive laundry detergent or cleaning composition having the following characteristics:
A water content of increasing preference 5 to 95, 10 to 90, 20 to 80, 30 to 70, 40 to 60, 45 to 55 wt. % and quite particularly preferably with a water content of 50 wt. %,
A content of an inorganic salt, preferably a sulfate, particularly preferably sodium sulfate, from 3 to 30 wt. %, preferably 5 to 20 wt. %, particularly 7 to 10 wt. % in the liquid, gelled or pasty phase and/or
A density of 1.00 to 1.50 g/ml, preferably 1.02 to 1.30 g/ml, particularly preferably 1.05 to 1.15 g/ml.

Indeed, by regulating the water content and/or the electrolyte content of these compositions and (thus probably associated) their density—which are known per se to the expert—they can be matched in regard to their physico-chemical properties to those of the granulate particles. The optimum of density, appearance and dissolution behavior of the particles and water content and/or electrolyte content and density of the compositions is to be determined experimentally case by case. In this regard, particular care is to be taken that the particles do not prematurely disintegrate. Advantageous, in many cases wanted and in this way achievable is a particle that floats in a liquid composition.

The density of the granulates described in Example 5 of the present application is ca. 1.094 g/ml, whereas that of the particles introduced here is ca. 1.29 g/ml. This instructs us that both densities do not have to be necessarily identical, rather that they can differ from one another within a certain margin. Indeed, there accrue still further surface effects (charges, hydrophobic/hydrophilic effects etc.) that in detail are to be compensated experimentally. Further, there occurs a stabilization of the floating particle by the flow behavior of the composition. The existence of a flow limit particularly provides an effective stabilization of the particle phase in liquid or gelled compositions.

Preferred embodiments of this subject matter of the invention concern an inventive laundry detergent or cleaning composition comprising a bleaching agent, selected from the group: enzymatic bleaching system, inorganic bleaching system, organic bleaching system or a mixture thereof.

Bleaching systems for use in laundry detergent and cleaning compositions are known per se and have already been stated above. Enzyme systems have also been described above and can be added in inventively granulated form or in another way in inventive compositions, as long as at least an inventive granulate is comprised. It can, for example, also be the substrate of such a bleaching system (see above).

Commensurate with these explanations, preferred embodiments of this aspect of the invention are formed by laundry detergent or cleaning compositions according to the invention, wherein the bleaching system concerns
(i) H₂O₂ or an H₂O₂-forming system, especially percarbonate,
(ii) H₂O₂ or an H₂O₂-forming system, in each case in combination with a peroxycarboxylic acid precursor, especially tetraacetyl ethylenediamine (TAED),
(iii) a preformed peroxycarboxylic acid, especially 1,12-diperoxydodecanedioic acid (DPDDA), phthalimidoperoxyhexanoic acid (PAP), particularly preferably PAP or
(iv) a combination of (a), (b) and/or (c).

Indeed, firstly this involves a particularly powerful bleaching agent (see above). Secondly, in the examples of the present application, there is illustrated precisely an inventive formulation that comprises additional PAP and spiked with corresponding particles. These examples demonstrate the advantage of the present invention.

Preferred embodiments of this aspect of the invention are laundry detergent and cleaning compositions according to the invention, wherein the bleaching agent is present in the liquid or gelled composition as particles, preferably as coated particles.

Possibilities for the realization of this thought have already been illustrated in the introduction. Reference may be made in particular to the applications WO 2004/110610 A1, WO 2004/1 10612 A1 and WO 2004/1 10611 A1. If the coatings described in them were also inadequate by themselves to stabilize the enzymes incorporated in liquid form, it is nevertheless advantageous to combine these proposals to encapsulate the bleaching agent with the inventive granulates of sensitive ingredients. An additionally improved protection of the sensitive ingredients is achieved in this way.

Preferred embodiments of this aspect of the invention are laundry detergent and cleaning compositions according to the invention, wherein the sensitive ingredient is an oxidative enzyme.

In this way the oxidizable enzyme is firstly protected against active compounds, for example from the highly concentrated surfactants of a liquid detergent formulation. Secondly, in this way enzyme and substrate can be at least essentially separated from one another, such that they are only able to react together in the moment of use, i.e. when the granulate particles burst open when strongly diluted with water. In this way the substrate is not prematurely used up and is practically completely available for the desired use.

In accordance with the previous embodiments, the present invention is also put into practice by suitable use possibilities in order to condition sensitive ingredients of laundry detergent and cleaning compositions in the form of comparatively stable granulates.

Consequently, according to the invention, the use of the components:

(b) particulate carrier material (adsorbent),

(c) an ingredient that is different from (b) as the binder and

(d) optional additional ingredients that are different from (b) und (c),

in order to manufacture, in an intimate mixture of these components with a sensitive ingredient of a laundry detergent or cleaning composition (component (a)), a granulate of this sensitive ingredient of a laundry detergent or cleaning composition which has a disintegration index of at least 50% after 24 hours.

In one of the previous explanations corresponding to a preferred use, the components (b) and (c) are present in a wt. % ratio of (b) to (c) of 1:50 to 50:1, preferably 1:20 to 20:1, particularly preferably 1:5 to 5:1.

The inventive use with the following components is correspondingly preferred:
(a) the sensitive ingredient of a laundry detergent or cleaning composition,
(b) 10-80 wt. % of a particulate carrier material (adsorbent),
(c) 3-50 wt. % of an ingredient that is different from (b) as the binder, and
(d) as the optional further ingredients that are different from (b) and (c):
   0-50 wt. % (based on the granulate) plasticizer,
   0-50 wt. % (based on the granulate) solubility enhancer (swelling agent, disintegration aid, disintegrant) and/or
   0-40 wt. % (based on the granulate) water, enzyme stabilizers, colorants, pigments, pH buffers, antioxidants, density-regulating compounds and/or additional ingredients.

The use according to the invention is correspondingly preferred, wherein the sensitive ingredient of the laundry detergent or cleaning composition concerns a perfume, an optical brightener, a bleach activator or an enzyme, preferably an enzyme, particularly preferably an enzyme stabilized against oxidation.

Further embodiments of this aspect of the invention result in a corresponding way from the previous illustrations of the granulate according to the invention, its manufacturing process and/or laundry detergent and cleaning compositions.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

Further embodiments and aspects of the invention result from the following examples.

### EXAMPLES

### Example 1

### Manufacture of the Enzyme Granulate E1

An extrudate (granulate E1) was manufactured from the following ingredients:

| | Quan- | |
|---|---|---|
| | tity | |
| No. | [g] | Ingredient |
| 1 | 80 | Polyvinyl alcohol (viscosity 4.5 ± 0.5; sapon- |
| | | ification number 270-310 mg KOH/g; commercial |
| | | product Erkol ® M05/290 from Erkol, Tarragona, |
| | | Spain) |
| 2 | 140 | Sodium stearate (Riedel-de Haën/Sigma- |
| | | Aldrich, Seelze, Germany) |
| 3 | 20 | Sodium aluminum silicate (mean particle size 3.5 μm; |
| | | commercial product Wessalith ® P = Wessalith ® 4000; |
| | | Degussa, Frankfurt/M., Germany) |
| 4 | 80 | Aluminum oxide (commercial product Disperal ® P3; |
| | | Sasol, Hamburg, Germany) |
| 5 | 60 | Titanium dioxide (Kronos, Leverkusen, Germany) |
| 6 | 456 | Liquid protease preparation (commercial product |
| | | comprising 95% water, remainder: pure enzyme |
| | | protein, stabilized by point mutagenesis |
| | | against oxidation, and 1,2-ethylene glycol as |
| | | stabilizer; ca. 160 000 HPE/g) |

All powdered and dried substances 1 to 5 were premixed and fed with a powder dosing unit into a twin screw extruder type 20/40D (Brabender Company, Duisburg, Germany) (screw diameter D: 20 mm; processing length of the extruder: 40×D, i.e. 800 mm). The temperature and pressure at the entry to the die were 50° C. and 30 bar respectively; the extruder torque was 37 Nm and screw speed was set at 100 rpm. The liquid component 6 was added at 12D by means of a type M5 Lewa Lab laboratory metering pump (Hermann Ott Company AG, Leonberg). The feed ratio of the powder to the liquid was 13:0.6-0.4.

Homogenization and melting then occurred in the process length of 28×D. For the conditioning, the enzyme compound was discharged through a circular strand die (diameter 1 mm) onto a belt take-off and after a cooling section of 1 m was fed into a granulator type 881203 (Brabender). The resulting cylindrical extrudate particles were mechanically rounded.

These granulates consisted of (a) ca. 5% pure enzyme; the other components were comprised in the following quantities: (b) 36 wt. % particulate carrier material, consisting of Wessalith, Dispersal and TiO₂, (c) 18 wt. % binder, consisting of PVA, (d) 31 wt. % plasticizer, consisting of sodium stearate, and ca. 10% water. A part of the particulate carrier material, namely the TiO₂, makes up 13% of the total mass of the granulate and additionally serves as a pigment. The weight ratio of (b) to (c) was ca. 2:1.

### Example 2

### Manufacture of the Enzyme Granulate E2

An extrudate (granulate E2) was manufactured from the following ingredients:

| | Quan- | |
|---|---|---|
| | tity | |
| No. | [g] | Ingredient |
| 1 | 110 | Polyvinyl alcohol (Erkol ® M05/290) |
| 2 | 120 | Sodium stearate (Riedel/Fluka) |
| 3 | 40 | Sodium aluminum silicate (Wessalith ® 4000) |
| 4 | 40 | Glucose |
| 5 | 80 | Aluminum oxide (Disperal ® P3) |
| 6 | 40 | Titanium dioxide (Kronos) |
| 7 | 516 | Liquid protease preparation (as in Example 1) |

The granulation was as in Example 1 except for the following differences:
All powdered or dried substances, i.e. components 1 to 6, were premixed and fed to the extruder;
The feed ratio of the powder to the liquid was 15:0.6-0.4.
the pressure was adjusted to 5 to 15 bar and the torque was 23 Nm.

These granulates consisted of (a) ca. 5% pure enzyme; the other components were comprised in the following quantities: (b) 31 wt. % particulate carrier material, consisting of Wessalith, Dispersal and TiO₂, (c) 22 wt. % binder, consisting of PVA, (d) 24 wt. % plasticizer, consisting of sodium stearate, 8 wt. % solubility enhancer, consisting of glucose and ca. 10% water. A part of the particulate carrier material, namely the TiO₂, makes up 8% of the total mass of the granulate and additionally serves as a pigment. The weight ratio of (b) to (c) was ca. 1.4:1.

### Example 3

### Manufacture of the Fluidized Bed Granulates E3, E4 and E5

The following carrier material components were used for the three further granulates:
(E3) sodium aluminum silicate, (Trade name Wessalith® 4000; manufacturer: Degussa, Frankfurt/M., Germany),
(E4) partially hydrolyzed PVA (Trade name Mowiol® 4-88; manufacturer: Clariant, Frankfurt/M., Germany) and
(E5) sodium sulfate

For the three granulates E3, E4 and E5, 600 g of each carrier were placed in the fluidised bed unit (Fielder-Aeromatic, Bubendorf, Switzerland). They were then sprayed at 60° C. with a mixture of 500 ml protease solution (Everlase® 16 L, Novozymes Company A/S) and with 500 ml of a 10% conc. solution of a polyacrylate (methacrylic acid-ethyl acrylate copolymer (1:1); commercial product Eudragit® L 100-55 from Röhm, Darmstadt, Germany; now Degussa, Frankfurt/M.), previously adjusted to pH 7.2 with concentrated sodium hydroxide. The thus obtained granulate was sieved to a particle size range of 0.6 mm-1.2 mm.

In addition to the protease component (ca. 5 wt. %) and water (ca. 10 wt. %), these granulates therefore comprised 78 wt. % of particulate carrier material (b) (sodium aluminum silicate, PVA or sodium sulfate) and 7 wt. % binder (c) (polyacrylate). The weight ratio of (b) to (c) was ca. 11:1.

### Example 4

### Manufacture of Coated Fluidized Bed-Granulates E3c, E4c and E5c

900 g of the respective enzyme granulates E3, E4 and E5 manufactured in Example 3 were sprayed at 60° C. in the fluidized bed unit used in Example 3 with 1800 ml of a 10% conc. solution of Eudragit® L 100-55 (see above), previously adjusted to pH 7.2 with concentrated sodium hydroxide, and to which 5% triethyl citrate (based on the polymer content) as the plasticizer had been added. The thus obtained coated enzyme granulates were sieved through a 2000 μm sieve. They were then identified as E3c, E4c and E5c.

The conditioned granulates E3c, E4c and E5c therefore comprised a coating that made up ca. 21% of the mass of each granulate core. The density of each of the coated granulates was ca. 1.29 g/ml.

### Example 5

### Manufacture of Liquid Heavy-Duty Laundry Detergents

Liquid heavy-duty laundry detergents were manufactured with the following compositions, wherein the quantity in wt. % is based on the respective content of active principle:

| | Quan- | |
|---|---|---|
| | tity | |
| | [wt. % | |
| No. | actives] | Ingredient |
| 1 | 16.5 | Linear sodium alkylbenzene sulfonate (commercial |
| | | product Maranil ®; Cognis, Düsseldorf) |
| 2 | 10 | Non-ionic surfactant (C₁₂₋₁₈ fatty alcohol |
| | | ethoxylate (7 EO); commercial product Dehydol ® LT 7; |
| | | Cognis) |
| 3 | 1 | Hydroxyethane-1,1-diphosphonic acid, Na4 salt |
| | | (HEDP; Sequion ® 10 H 60; Polygon Chemie, Olten, |
| | | Switzerland) |
| 4 | 3 | Sodium citrate |
| 5 | 8 | Sodium sulfate |
| 6 | 3 | Phthalimidoperoxyhexanoic acid (PAP) as granulate |
| | | (400-1200 μm; commercial product Eureco ® W; Solvay |
| | | Solexis; Bussi, Italy) |
| 7 | 3.5 | Enzyme granulate E1, E2, E3c, E4c or E5c |
| 8 | 0.25 | Xanthane gum; commercial product TGCS; |
| | | Jungbunzlauer Xanthan, Pernhofen, Austria) |
| 9 | 1 | Perfume |
| 10 | 0.1 | Silicone defoamer (commercial product DC 2-3910; |
| | | Wacker, Munich) |
| 11 | ad 100 | Water |

Manufacturing involved placing the water in a stirring vessel followed by the addition of the Xanthane. After the Xanthane had swelled up (30 min), the sulfate was added. The surfactants and the additional raw materials were then added in the given order with stirring. The pH was adjusted to 5.0±0.2 with concentrated NaOH.

The liquid heavy-duty laundry detergent formulations obtained in this way were F1 (with E1), F2 (with E2), F3c (with E3c), F4c (with E4c) and F5c (with E5c).

The density of the liquid phase was determined to be ca. 1.094 g/ml.

### Example 6

### Manufacture of Comparative Formulations According to the Prior Art

Liquid heavy-duty laundry detergents were manufactured with the formulation given in Example 5, but with the difference that commercially available supply forms of the protease were employed as the component 7, namely the protease Everlase from Novozymes A/S, Bagsvaerd, Denmark. The following comparative formulations were obtained:
V1: with 3.5% Everlase® 12 T (granulate)
V2: with 2% Everlase® 16 L (liquid enzyme), residual in the formulation: water

It can be assumed that the coating of this granulate comprises PEG and titanium dioxide as the essential ingredients, in agreement with numerous descriptions from the prior art, for example the application WO 97/39116 A1.

### Example 7

### Determination of the Storage Stabilities

The formulations F1, F2, F3c, F4c, F5c and V1 and V2 manufactured according to the preceding Example were stored in sealed, gas-tight glass bottles at a storage temperature of 25° C. The enzyme activity was determined by means of a “Continuous Flow Apparatus” (Skalar Company, Erkelenz) after storage times of 1, 2, 4 and 8 weeks. The method is based on casein cleavage, dyeing the hydrolysis products with trinitrobenzene sulfonic acid and subsequent photometric measurement. In principle, any other method for determining protease activity could be used, as long as the method is not impaired by the presence of surfactants.

In the following Table, the percentage residual activity of the protease, based on the initial activity measured directly after sample preparation, is given after the respective storage times:

| Sample | 1 week | 2 weeks | 4 weeks | 8 weeks |
|---|---|---|---|---|
| V1 | 45 | 30 | 15 | 0 |
| V2 | 0 | 0 | 0 | 0 |
| F1 | 96 | 89 | 77 | 55 |
| F2 | 94 | 87 | 75 | 48 |
| F3c | 92 | 87 | 69 | 40 |
| F4c | 95 | 88 | 68 | 45 |
| F5c | 100 | 89 | 77 | 56 |

It can be observed that the enzyme present in liquid form in sample V2 is completely inactivated within the shortest time, probably by the comprised bleaching agent.

The commercially available enzyme granulate in V1 shows a higher, although in no way acceptable stability. Consequently, the granulation and coating can only inadequately prevent an interaction of the bleaching agent during storage. In addition, it was observed for V1 that its granulates disintegrate over time.

In contrast, the uncoated granulates E1 and E2 already demonstrate a high enzyme activity that is retained significantly longer, thus implying a de facto higher enzyme stability. This is particularly noteworthy, as the formulation in question comprises more than 50 wt. % water. In regard to their form, both granulates remain unchanged, i.e. they do not disintegrate.

The results for the formulations E3c, E4c and E5c show that a substantial stabilization can also be achieved with the added help of the selected coating agent. The absolute best values are shown by E5c with sodium sulfate as the particulate carrier material of the core, followed by E4c with PVA as the carrier material of the core. In regard to their form, both granulates also remain unchanged, i.e. they do not disintegrate.

A combination of E1 (granulate core with PVA, sodium stearate, sodium aluminum silicate, aluminum oxide and titanium dioxide) with a coating according to Example 4 (polyacrylate/triethyl citrate) provided an additional stability increase.

### Example 8

### Manufacture of the Enzyme Granulate E6

An extrudate (granulate E6) was manufactured as described in Example 1 from the following ingredients:

| | Quan- | Quan- | |
|---|---|---|---|
| | tity | tity | |
| No. | [g] | [wt. %] | Ingredient |
| 1 | 80 | 13 | Polyvinyl alcohol (viscosity 4.5 ± 0.5; |
| | | | saponification number 270-310 mg |
| | | | KOH/g; commercial product Erkol ® |
| | | | M05/290 from Erkol, Tarragona, Spain) |
| 2 | 80 | 13 | Sodium oleate (Riedel-de Haën/ |
| | | | Sigma-Aldrich, Seelze, Germany) |
| 3 | 60 | 9.7 | Sodium stearate (Riedel-de Haën/ |
| | | | Sigma-Aldrich, Seelze, Germany) |
| 4 | 60 | 9.7 | Sodium sulfate (Riedel-de Haën/ |
| | | | Sigma-Aldrich, Seelze, Germany) |
| 5 | 80 | 13 | Crosslinked polyvinyl pyrrolidone |
| | | | (commercial product Collidon ® CL |
| | | | from BASF, Ludwigshafen) |
| 6 | 260 | 42 | Liquid protease preparation |
| | | | (commercial product comprising ca. 10 |
| | | | wt. % pure enzyme protein, stabilized |
| | | | by point mutagenesis against oxidation, |
| | | | remainder: water and 1,2-ethylene |
| | | | glycol as stabilizer; ca. 160 000 |
| | | | HPE/g) |

This formulation thus comprised with no. 6, ca. 4.2 wt. % enzyme as the sensitive ingredient (a), with nos. 1 and 4 together, 22.7 wt. % component (b), with no. 5, 13 wt. % component (c), with nos. 2 and 3 together, 22.7 wt. % plasticizer as part of component (d) and water as the main residual.

A part of E6 was subsequently coated as described in Example 4, the coated granulate being called E6c.

### Example 9

### Manufacture of the Enzyme Granulate E7

An extrudate (granulate E7) was manufactured as described in Example 1 from the following ingredients:

| | Quan- | Quan- | |
|---|---|---|---|
| | tity | tity | |
| No. | [g] | [wt. %] | Ingredient |
| 1 | 80 | 16 | Polyvinyl alcohol (viscosity 4.5 ± |
| | | | 0.5; saponification number 270-310 |
| | | | mg KOH/g; commercial product Erkol ® |
| | | | M05/290 from Erkol, Tarragona, Spain) |
| 2 | 60 | 12 | Sodium stearate (Riedel-de Haën/ |
| | | | Sigma-Aldrich, Seelze, Germany) |
| 3 | 80 | 16 | Sodium sulfate (Riedel-de Haën/ |
| | | | Sigma-Aldrich, Seelze, Germany) |
| 4 | 80 | 16 | Crosslinked polyvinyl pyrrolidone |
| | | | (commercial product Collidon ® CL |
| | | | from BASF, Ludwigshafen) |
| 5 | 200 | 40 | Liquid protease preparation |
| | | | (commercial product comprising ca. |
| | | | 10 wt. % pure enzyme protein, stabilized |
| | | | by point mutagenesis against oxidation, |
| | | | remainder: water and 1,2-ethylene glycol |
| | | | as stabilizer; ca. 160 000 HPE/g) |

This formulation thus comprised with no. 5, ca. 4 wt. % enzyme as the component (a), with nos. 1 and 3 together, 32 wt. % component (b), with no. 4, 16 wt. % component (c), with no. 2, 12 wt. % plasticizer as part of component (d) and water as the main residual.

A part of E7 was subsequently coated as described in Example 4, the coated granulate being called E7c.

### Example 10

### Manufacture of the Enzyme Granulate E8

An extrudate (granulate E8) was manufactured as described in Example 1 from the following ingredients:

| | Quan- | Quan- | |
|---|---|---|---|
| | tity | tity | |
| No. | [g] | [wt. %] | Ingredient |
| 1 | 80 | 16 | Polyvinyl alcohol (viscosity 4.5 ± |
| | | | 0.5; saponification number 270-310 mg |
| | | | KOH/g; commercial product Erkol ® |
| | | | M05/290 from Erkol, Tarragona, Spain) |
| 2 | 60 | 12 | Sodium stearate (Riedel-de Haën/ |
| | | | Sigma-Aldrich, Seelze, Germany) |
| 3 | 60 | 12 | Sodium sulfate (Riedel-de Haën/ |
| | | | Sigma-Aldrich, Seelze, Germany) |
| 4 | 20 | 4 | Methacrylic acid-ethyl acrylate |
| | | | copolymer (commercial product |
| | | | Eudragit ® L 100 from Degussa, |
| | | | Frankfurt/M.) |
| 5 | 80 | 16 | Crosslinked polyvinyl pyrrolidone |
| | | | (commercial product Collidon ® |
| | | | CL from BASF, Ludwigshafen) |
| 6 | 200 | 40 | Liquid protease preparation |
| | | | (commercial product comprising ca. |
| | | | 10 wt. % pure enzyme protein, |
| | | | stabilized by point mutagenesis |
| | | | against oxidation, remainder: |
| | | | water and 1,2-ethylene glycol as |
| | | | stabilizer; ca. 160 000 HPE/g) |

This formulation thus comprised with no. 6, ca. 4 wt. % enzyme as the component (a), with nos. 1 and 3 together, 28 wt. % component (b), with nos. 4 and 5, 20 wt. % component (c), with no. 2, 12 wt. % plasticizer as part of component (d) and water as the main residual.

A part of E8 was subsequently coated as described in Example 4, the coated granulate being called E8c.

### Example 11

### Disintegration Test of Enzyme Granulates

The disintegration rate of the enzyme granulates was determined by subjecting the granulates E7, E7c, E8, E8c and E5c from the preceding examples and both the commercial products K1 (Purafect® OX4000E; Genencor) and K2 (Everlase® 12T; Novozymes) as controls to the following disintegration test:

To each 1 g of the respective enzyme preparation weighed out in a 50 ml glass bottle were added 30 ml of a 16% Na sulfate/3% Na citrate solution that had been adjusted to pH 5.0 with 10% conc. sulfuric acid. This mixture was shaken for 24 h at 23° C. in a laboratory shaker (Certomat® U, Braun, Melsungen) at 100 rpm. This thus treated dispersion was then filtered through an E-D sieve, mesh size 0.28 mm, without applied pressure, and rinsed with 50 ml distilled water.

The sieve was dried at 35° C. for 48 h, the granulate remaining on the sieve was weighed and compared with the starting value. Double determinations were carried out on each sample.

The following results were obtained:

| Granulate | Residue [wt. %] |
|---|---|
| K1 | 45 |
| K2 | 7 |
| E7 | 60 |
| E7c | 70 |
| E8 | 66 |
| E8c | 70 |
| E5c | 89 |

It can be seen that the granulate K₂ corresponding to that of the prior art delivered by far the worst results, i.e. substantially disintegrated.

The granulate K1 disintegrated by more than 50%. In addition, it was observed that in these granulates, the majority of the enzyme-containing active layer dissolved away.

The granulates according to the invention, E7, E7c, E8, E8c, E5c, clearly show residual values of more than 50%, meaning that the majority of the granulate does not disintegrate on storage (and even when shaken) in the test solution. Thus, they fulfill the requirements of the invention.

Furthermore, it can be observed that an additional stabilization is afforded to the granulates according to the invention by depositing a coating.

What is claimed:

1. A granulate for sensitive ingredients of laundry detergents or cleaning compositions, comprising:
(a) a sensitive ingredient of a laundry detergent or cleaning composition;
(b) a particulate adsorbent carrier material;
(c) a binder that is different from (b); and
(d) optional additional ingredients that are different from (b) and (c),
wherein the granulate has a disintegration index of at least 50% after 24 hours.

2. The granulate of claim 1, wherein the components (b) and (c) are present in a weight ratio of (b) to (c) of 1:50 to 50:1.

3. The granulate of claim 1, comprising:
(a) the sensitive ingredient of a laundry detergent or cleaning composition,
(b) 10-80 weight percent of the particulate adsorbent carrier material;
(c) 3-50 weight percent of the binder that is different from (b); and
(d) as optional further ingredients that are different from (b) and (c):
0-50 weight percent plasticizer;
0-50 weight percent solubility enhancer; or
0-40 weight percent water, enzyme stabilizers, colorants, pigments, pH buffers, antioxidants, density-regulating compounds, or additional ingredients.

4. The granulate of claim 1, wherein the sensitive laundry detergent or cleaning composition ingredient (a) is a perfume, an optical brightener, a bleach activator, or an enzyme.

5. The granulate of claim 1, wherein the adsorbent (b) is talcum, silicic acid, aluminum oxide, silicate, layered silicate, sodium aluminum silicate, bentonite, alumosilicate, zeolite, sulfate, titanium dioxide, polyvinyl alcohol, or partially hydrolyzed polyvinly alcohol.

6. The granulate of claim 1, wherein the binder is polyacrylate, polymethacrylate, polyvinyl pyrrolidone, polysaccharide, substituted polysaccharide, cellulose ether, polyvinyl alcohol, partially hydrolyzed polyvinyl alcohol, ethoxylated polyvinyl alcohol, or a copolymer thereof.

7. The granulate of claim 3, wherein the plasticizer is sodium stearate or sodium oleate.

8. The granulate of claim 3, wherein the solubility enhancer is a water-soluble inorganic salt, monosaccharide, glucose, oligosaccharide, polysaccharide, cellulose, compacted cellulose, cellulose derivative, crosslinked organic polymer, crosslinked polyvinyl pyrrolidone, or crosslinked polyacrylate.

9. The granulate of claim 1, further comprising a single or multilayer coating.

10. The granulate of claim 9, wherein the coating comprises more than 50 weight percent of one or more water-dispersible substances, water-dispersible or water-soluble polymer, fatty acid, salt of a fatty acid, fatty alcohol, paraffin, polyvinyl acetate, polyacrylate, polymethacrylate, methacrylic acid-ethyl acrylate copolymer, polyvinyl pyrrolidone, cellulose ether, polyvinyl alcohol or ethoxylated polyvinyl alcohol.

11. The granulate of claim 1, comprising a single or multilayer coating, wherein the coating comprises 5 to 100 weight percent of the uncoated granulate.

12. The granulate of claim 1, having an average density of 1.00 to 1.50 g/ml.

13. A process for the manufacture of a granulate, comprising the steps of adsorbing a sensitive laundry detergent or cleaning composition ingredient (a) onto a particulate adsorbent carrier material (b), mixing the components (a) and (b) with a binder (c) that is different from component (b), and forming the mixed ingredients (a), (b), and (c) into a granular form, wherein the granulate has a disintegration index of at least 50 percent after 24 hours.

14. The process of claim 13, wherein the adsorbent (b) is present as a predominantly dry substance, and the component (a) is an enzyme incorporated as a liquid preparation.

15. A laundry detergent or cleaning composition comprising a surfactant and the granulate of claim 1.

16. The laundry detergent or cleaning composition of claim 15, in a liquid, gel, or paste form.

17. The laundry detergent or cleaning composition of claim 16, having a water content of 5 to 95 weight percent.

18. The laundry detergent or cleaning composition of claim 16, having an inorganic salt content of 3 to 30 weight percent in the liquid, gel, or paste phase.

19. The laundry detergent or cleaning composition of claim 15, having a density of 1.00 to 1.50 g/ml.

20. The laundry detergent or cleaning composition of claim 15, comprising a enzymatic bleaching system, an inorganic bleaching system, an organic bleaching system or a mixture thereof.

21. The laundry detergent or cleaning composition of claim 20, wherein the bleaching agent is:
(i) H₂O₂ or an H₂O₂-forming system;
(ii) H₂O₂ or an H₂O₂ forming system comprising a peroxycarboxylic acid precursor;
(iii) a preformed peroxycarboxylic acid; or
(iV) a combination of (i), (ii) or (iii).

22. The process of claim 13, wherein the components (b) and (c) are present in a weight ratio of (b) to (c) of 1:50 to 50:1.
